(19) United States
(12) Patent Application Publication
(10) Pub. No.: US 2026/0016712 A1
(43) Pub. Date: Jan. 15, 2026

(54) WAVE CONTROL DEVICE, WAVELENGTH CONVERSION ELEMENT, ARITHMETIC ELEMENT, SENSOR, POLARIZATION CONTROL ELEMENT, AND OPTICAL ISOLATOR

(71) Applicant: Sony Group Corporation, Tokyo (JP)

(72) Inventors: Yoshihiro HONDA, Tokyo (JP); Eri IGARASHI, Tokyo (JP); Tomohiro AMEMIYA, Tokyo (JP)

(21) Appl. No.: 18/837,785

(22) PCT Filed: Jan. 13, 2023
(86) PCT No.: PCT/JP2023/000812

§ 371 Date: Mar. 3, 2025

(30) Foreign Application Priority Data
Feb. 14, 2022 (JP) 2022-020734
Mar. 3, 2022 (JP) 2022-032281

(51) Int. Cl. G02F 1/095

(52) U.S. Cl. CPC G02F 1/095

(57) ABSTRACT

Provided is a wave control device capable of improving controllability of an electromagnetic wave.

A wave control device according to the present technology includes a metamaterial and a magnetic material. According to the wave control device according to the present technology, a wave control device capable of improving controllability of an electromagnetic wave is provided. According to the present technology, it is possible to provide a wave control device capable of improving controllability of an electromagnetic wave.

### TECHNICAL FIELD

The present technology relates to a technique using a wave control device, and more specifically, to a technique for controlling an electromagnetic wave using a metamaterial.

### BACKGROUND ART

Conventionally, a technique for controlling an electromagnetic wave using a metamaterial is known (See, for example, Patent Documents 1 to 3.).

### CITATION LIST

### Patent Document

Patent Document 1: U.S. Pat. No. 8,615,150
Patent Document 2: U.S. Pat. No. 9,274,045
Patent Document 3: US 2021/0,063,779 A

### SUMMARY OF THE INVENTION

### Problems to be Solved by the Invention

However, in the conventional technique, there is room for improvement in improving the controllability of the electromagnetic wave.

Therefore, a main object of the present technology is to provide a wave control device capable of improving controllability of an electromagnetic wave.

### Solutions to Problems

The present technology provides a wave control device including a metamaterial and a magnetic material.

The metamaterial may be disposed and a magnetization direction of the magnetic material may be set such that an electromagnetic effect and a magneto-optical effect, and/or an interaction between the electromagnetic effect and the magneto-optical effect occur with respect to an electromagnetic wave.

The metamaterial may be disposed and the magnetization direction of the magnetic material may be set such that at least the interaction between the electromagnetic effect and the magneto-optical effect occurs with respect to the electromagnetic wave.

The metamaterial may be disposed and the magnetization direction of the magnetic material may be set such that the electromagnetic effect and the magneto-optical effect further occur with respect to the electromagnetic wave.

The metamaterial may be disposed around a waveguide of the electromagnetic wave.

The metamaterial may be provided integrally with the waveguide.

A core of the waveguide may be the magnetic material.

The metamaterial may be provided on an outer surface of the core.

A waveguide member including a core of the waveguide may be further included.

The metamaterial and the magnetic material may be provided on an outer surface of the core.

The metamaterial and the magnetic material may be disposed on a propagation path of the electromagnetic wave.

The metamaterial and the magnetic material may be disposed side by side along a propagation direction of the electromagnetic wave.

The metamaterial may be provided on the magnetic material.

The metamaterial may be disposed and the magnetization direction of the magnetic material may be set such that only a polarization state of one of a forward wave and a backward wave of the electromagnetic wave changes.

The metamaterial may be disposed and the magnetization direction of the magnetic material may be set such that a difference in effective refractive index between right circularly polarized light and left circularly polarized light of the forward wave of the electromagnetic wave is different from a difference in effective refractive index between right circularly polarized light and left circularly polarized light of the backward wave of the electromagnetic wave.

The metamaterial may include a split-ring resonator, a magnetic moment direction of the split-ring resonator and a waveguide direction of the electromagnetic wave may be substantially perpendicular, and the magnetic moment direction and the magnetization direction of the magnetic material may be substantially parallel. In this case, a split direction of the split-ring resonator may be substantially parallel to the waveguide direction or substantially perpendicular to the waveguide direction.

The metamaterial may include a split-ring resonator, a magnetic moment direction of the split-ring resonator and a waveguide direction of the electromagnetic wave may be substantially perpendicular, and the magnetic moment direction and the magnetization direction of the magnetic material may be substantially perpendicular. In this case, a split direction of the split-ring resonator may be substantially perpendicular to both the waveguide direction and the magnetization direction, may be substantially perpendicular to the waveguide direction and substantially parallel to the magnetization direction, may be substantially parallel to both the waveguide direction and the magnetization direction, or may be substantially parallel to the waveguide direction and substantially perpendicular to the magnetization direction.

The metamaterial may include any of a cut-wire pair resonator, a spiral resonator, a mushroom resonator, a V-shaped resonator, and a fishnet resonator.

The electromagnetic wave may be guided in a TM mode.

The magnetization direction of the magnetic material may be set by an external magnetic field.

The present technology also provides a wavelength conversion element including the above-described wave control device.

The present technology also provides an arithmetic element including the above-described wave control device.

The present technology also provides a sensor including the above-described wave control device.

The present technology also provides a polarization control element including the above-described wave control device.

The present technology also provides an optical isolator including the above-described wave control device.

### BRIEF DESCRIPTION OF DRAWINGS

FIG. 1 is a diagram illustrating formulas representing relationships among an electric flux density, a magnetic flux density, an electric field, and a magnetic field.

FIG. 2A is a determinant of FIG. 1 in a case of a general medium. FIG. 2B is a determinant of FIG. 1 in a case of a magnetic material. FIG. 2C is a determinant of FIG. 1 in a case of a multiferroic material.

FIGS. 3A to 3C are diagrams for explaining that an MO tensor can be controlled by a magnetization direction of the magnetic material.

FIGS. 4A to 4F are diagrams for explaining that an ME tensor can be controlled by an arrangement of a metamaterial.

FIGS. 5A and 5B are diagrams for explaining that the MO tensor and the ME tensor can be controlled at the same time.

FIGS. 6A and 6B are diagrams for explaining an example in which only the ME effect occurs.

FIGS. 7A and 7B are diagrams for explaining an example in which the MO effect, the ME effect, and an interaction between the MO effect and the ME effect occur.

FIGS. 8A and 8B are diagrams for explaining a concept of a wave control device according to a first embodiment of the present technology.

FIG. 9 is a perspective view of a wave control device according to Example 1 of the first embodiment of the present technology.

FIG. 10 is a perspective view of a wave control device according to Example 2 of the first embodiment of the present technology.

FIG. 11 is a perspective view of a wave control device according to Example 3 of the first embodiment of the present technology.

FIG. 12 is a perspective view of a wave control device according to Example 4 of the first embodiment of the present technology.

FIG. 13 is a perspective view of a wave control device according to Example 5 of the first embodiment of the present technology.

FIGS. 14A and 14B are diagrams for explaining a concept of a wave control device according to a second embodiment of the present technology.

FIG. 15 is a perspective view of a wave control device according to Example 1 of the second embodiment of the present technology.

FIG. 16 is a perspective view of a wave control device according to Example 2 of the second embodiment of the present technology.

FIG. 17 is a perspective view of a wave control device according to Example 3 of the second embodiment of the present technology.

FIG. 18 is a perspective view of a wave control device according to Example 4 of the second embodiment of the present technology.

FIG. 19 is a perspective view of a wave control device according to Example 5 of the second embodiment of the present technology.

FIGS. 20A and 20B are diagrams for explaining a concept of a wave control device according to a third embodiment of the present technology.

FIG. 21 is a perspective view of a wave control device according to Example 1 of the third embodiment of the present technology.

FIG. 22 is a perspective view of a wave control device according to Example 2 of the third embodiment of the present technology.

FIG. 23 is a perspective view of a wave control device according to Example 3 of the third embodiment of the present technology.

FIG. 24 is a perspective view of a wave control device according to Example 4 of the third embodiment of the present technology.

FIG. 25 is a perspective view of a wave control device according to Example 5 of the third embodiment of the present technology.

FIGS. 26A and 26B are diagrams for explaining a concept of a wave control device according to a fourth embodiment of the present technology.

FIG. 27 is a perspective view of a wave control device according to Example 1 of the fourth embodiment of the present technology.

FIG. 28 is a perspective view of a wave control device according to Example 2 of the fourth embodiment of the present technology.

FIG. 29 is a perspective view of a wave control device according to Example 3 of the fourth embodiment of the present technology.

FIG. 30 is a perspective view of a wave control device according to Example 4 of the fourth embodiment of the present technology.

FIG. 31 is a perspective view of a wave control device according to Example 5 of the fourth embodiment of the present technology.

FIGS. 32A and 32B are diagrams for explaining a concept of a wave control device according to a fifth embodiment of the present technology.

FIG. 33 is a perspective view of a wave control device according to Example 1 of the fifth embodiment of the present technology.

FIG. 34 is a perspective view of a wave control device according to Example 2 of the fifth embodiment of the present technology.

FIG. 35 is a perspective view of a wave control device according to Example 3 of the fifth embodiment of the present technology.

FIG. 36 is a perspective view of a wave control device according to Example 4 of the fifth embodiment of the present technology.

FIG. 37 is a perspective view of a wave control device according to Example 5 of the fifth embodiment of the present technology.

FIGS. 38A and 38B are diagrams for explaining a concept of a wave control device according to a sixth embodiment of the present technology.

FIG. 39 is a perspective view of a wave control device according to Example 1 of the sixth embodiment of the present technology.

FIG. 40 is a perspective view of a wave control device according to Example 2 of the sixth embodiment of the present technology.

FIG. 41 is a perspective view of a wave control device according to Example 3 of the sixth embodiment of the present technology.

FIG. 42 is a perspective view of a wave control device according to Example 4 of the sixth embodiment of the present technology.

FIG. 43 is a perspective view of a wave control device according to Example 5 of the sixth embodiment of the present technology.

FIGS. 44A and 44B are diagrams illustrating Specific Examples 1 and 2 of the shape of the metamaterial.

FIGS. 45A and 45B are diagrams illustrating Specific Examples 3 and 4 of the shape of the metamaterial.

FIGS. 46A and 46B are diagrams illustrating Specific Examples 5 and 6 of the shape of the metamaterial.

FIGS. 47A and 47B are diagrams for explaining Specific Example 7 of the shape of the metamaterial.

FIGS. 48A and 48B are diagrams for explaining Specific Example 8 of the shape of the metamaterial.

FIG. 49A is a diagram illustrating a slab waveguide structure used for calculation of a propagation constant β of the wave control device according to the fifth embodiment of the present technology. FIG. 49B is a diagram illustrating a non-reciprocal loss difference in a case where an uppermost layer in FIG. 49A is configured of a magnetic material in the calculation of the propagation constant β of the wave control device according to the fifth embodiment of the present technology. FIG. 49C is a diagram illustrating a non-reciprocal phase difference in a case where the uppermost layer in FIG. 49A is configured of a magnetic material in the calculation of the propagation constant β of the wave control device according to the fifth embodiment of the present technology. FIG. 49D is a diagram illustrating a non-reciprocal loss difference in a case where the uppermost layer in FIG. 49A is configured of a metamaterial and a magnetic material in the calculation of the propagation constant β of the wave control device according to the fifth embodiment of the present technology. FIG. 49E is a diagram illustrating a non-reciprocal phase difference in a case where the uppermost layer in FIG. 49A is configured of a metamaterial and a magnetic material in the calculation of the propagation constant β of the wave control device according to the fifth embodiment of the present technology.

FIGS. 50A and 50B are diagrams for explaining free space propagation (forward wave) considering only the MO effect.

FIGS. 51A and 51B are diagrams for explaining free space propagation (backward wave) considering only the MO effect.

FIGS. 52A and 52B are diagrams for explaining free space propagation (forward wave) considering only the ME effect.

FIGS. 53A and 53B are diagrams for explaining free space propagation (backward wave) considering only the ME effect.

FIGS. 54A and 54B are diagrams for explaining an example of free space propagation (forward wave) considering the MO effect and the ME effect.

FIGS. 55A and 55B are diagrams for explaining an example of free space propagation (backward wave) considering the MO effect and the ME effect.

FIGS. 56A and 56B are diagrams for explaining another example of the free space propagation (forward wave) considering the MO effect and the ME effect.

FIGS. 57A and 57B are diagrams for explaining another example of the free space propagation (backward wave) considering the MO effect and the ME effect.

FIG. 58A is a perspective view of a wave control device according to Example 1 of a seventh embodiment of the present technology. FIG. 58B is a diagram for explaining an arrangement of a metamaterial and a magnetic material in the wave control device of FIG. 58A, in which unidirectionally limited polarization controllability can be exhibited.

FIG. 59A is a perspective view of a wave control device according to Example 2 of the seventh embodiment of the present technology. FIG. 59B is a diagram for explaining an arrangement of a metamaterial and a magnetic material in the wave control device of FIG. 59A, in which unidirectionally limited polarization controllability can be exhibited.

FIG. 60A is a perspective view of a wave control device according to Example 3 of the seventh embodiment of the present technology. FIG. 60B is a diagram for explaining an arrangement of a metamaterial and a magnetic material in the wave control device of FIG. 60A, in which unidirectionally limited polarization controllability can be exhibited.

FIGS. 61A and 61B are diagrams for explaining conditions under which the unidirectionally limited polarization controllability is exhibited.

### MODE FOR CARRYING OUT THE INVENTION

Hereinafter, preferred embodiments for carrying out the present technology will be described with reference to the drawings. Embodiments to be described hereinafter illustrate examples of representative embodiments of the present technology, and any embodiments can be combined. Furthermore, the scope of the present technology is not narrowly construed based on these. Note that the description is given in the following order.
0. Introduction
1. Wave control device according to first embodiment of present technology
2. Wave control device according to second embodiment of present technology
3. Wave control device according to third embodiment of present technology
4. Wave control device according to fourth embodiment of present technology
5. Wave control device according to fifth embodiment of present technology
6. Wave control device according to sixth embodiment of the present technology
7. Wave control device according to seventh embodiment of present technology
8. Specific examples of shape of metamaterial
9. Modifications of present technology
10. Application of present technology

### 0. Introduction

By the way, for example, by applying an external magnetic field to a ferromagnetic material, a non-diagonal component of a dielectric constant can be controlled, and a polarization state of an electromagnetic wave transmitted/reflected by a medium can be controlled. This phenomenon is known as a magneto-optical (MO) effect, and is applied as an optical isolator such as a Faraday rotation element.

Furthermore, in recent years, multiferroic materials that generate an (ME effect) that allows a magnetic response of a medium to be controlled by an electric field and an electrical response of a medium to be controlled by a magnetic field have attracted attention as next-generation new memories and energy conversion devices.

In recent years, further improvement of controllability of electromagnetic waves is expected. Therefore, the inventors have found that only one of the MO effect and the ME effect is insufficient in terms of controllability of electromagnetic waves, and after intensive studies, have developed a wave control device that exhibits at least the MO effect (magneto-optical effect) and the ME effect (electromagnetic effect) and a wave control device that exhibits at least an interaction between the MO effect and the ME effect by combining a metamaterial and a magnetic material.

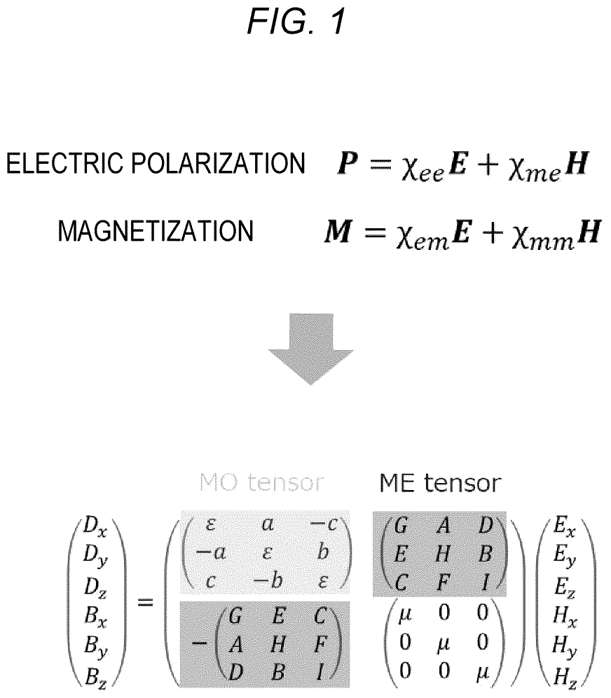

A general relationship among an electric flux density D, a magnetic flux density B, an electric field E, and a magnetic field H in consideration of the MO effect and the ME effect can be expressed as in FIG. 1. In the lower drawing of FIG. 1, a tensor regarding the MO effect is a light gray MO tensor, and a tensor regarding the ME effect is a dark gray ME tensor. Note that it is a novel attempt to formulate the relationship of D, B, E, and H in association with a 6×6 matrix as illustrated in the lower drawing of FIG. 1. Note that, in the lower drawing of FIG. 1, ε represents a dielectric constant of a medium, and μ represents a magnetic permeability of the medium.

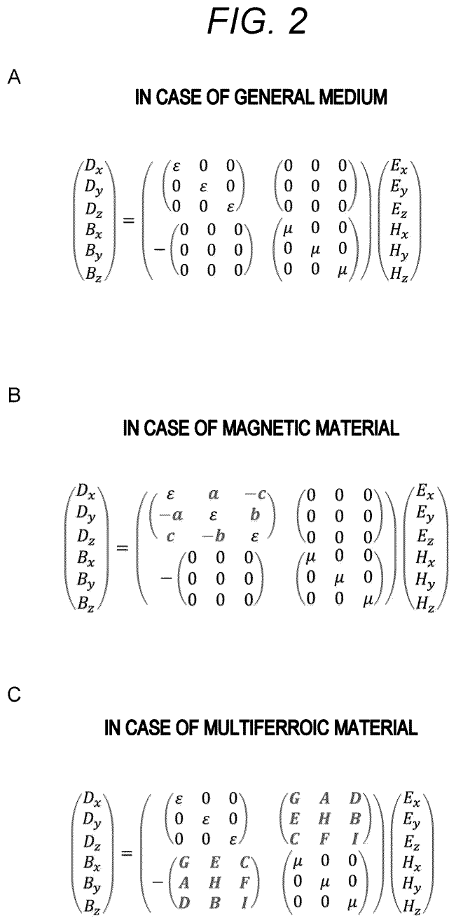

As illustrated in FIG. 2A, in the case of a general medium (for example, a non-magnetic material), the MO tensor in the lower diagram of FIG. 1 has a value only for diagonal components, and has 0 for all non-diagonal components (a to c=0). Furthermore, the ME tensor in the lower drawing of FIG. 1 has 0 (A to I=0) for both the diagonal components and the non-diagonal components. That is, the general medium controls electric polarization by an electric field and controls magnetization by a magnetic field. In the general medium, an application direction of the electric field coincides with a direction of the electric polarization, and an application direction of the magnetic field coincides with a magnetization direction (scalar quantity). Therefore, the general medium can control reflection and refraction of an electromagnetic wave (for example, light).

As illustrated in FIG. 2B, in the case of the magnetic material, the MO tensor in the lower diagram of FIG. 1 has a value for both the diagonal components and the non-diagonal components, and the ME tensor in the lower drawing of FIG. 1 has a value of 0 (A to I=0) for both the diagonal components and the non-diagonal components. That is, the magnetic material controls the electric polarization by the electric field and controls the magnetization by the magnetic field. In the magnetic material, the application direction of the electric field does not coincide with the direction of the electric polarization, and polarization of the electromagnetic wave (for example, polarization of light) can be controlled.

As illustrated in FIG. 2C, in the case of the multiferroic material, the MO tensor in the lower drawing of FIG. 1 has values of a to c=0 only for the diagonal components, and the ME tensor in the lower drawing of FIG. 1 has values of both the diagonal components and the non-diagonal components. That is, the multiferroic material controls the magnetization by the electric field and controls the electric polarization by the magnetic field. Thus, the multiferroic material can control reflection, refraction, polarization, and the like of then electromagnetic wave (for example, light) by both the magnetic field and the electric field.

As described above, conventionally, a material capable of freely controlling both the MO tensor and the ME tensor has not been developed.

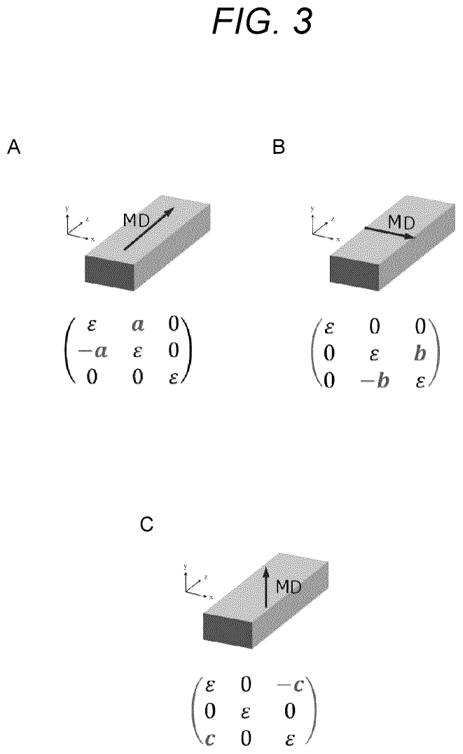

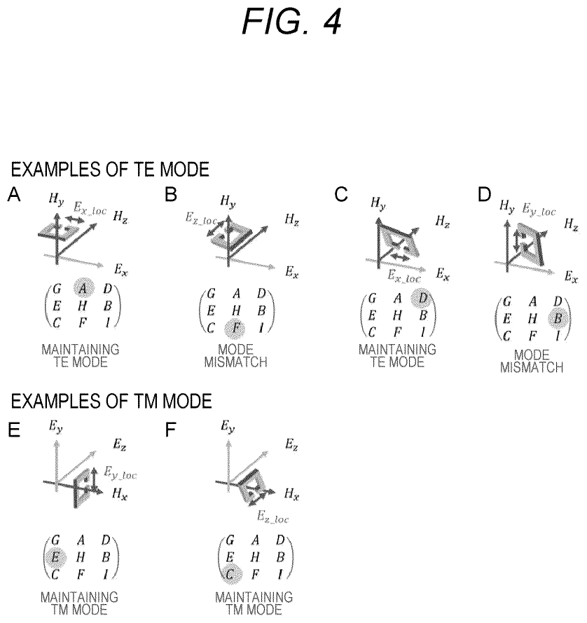

Here, as illustrated in FIGS. 3A to 3C, it can be seen that the non-diagonal components of the MO tensor can be controlled by the magnetization direction MD of the magnetic material (for example, a rectangular parallelepiped). As illustrated in FIGS. 4A to 4F, it can be seen that an arrangement of the metamaterial (e.g., a split-ring resonator) can control the diagonal and non-diagonal components of the ME tensor. Note that FIGS. 4A to 4D illustrate examples of the TE mode, and FIGS. 4E and 4F illustrate examples of the TM mode.

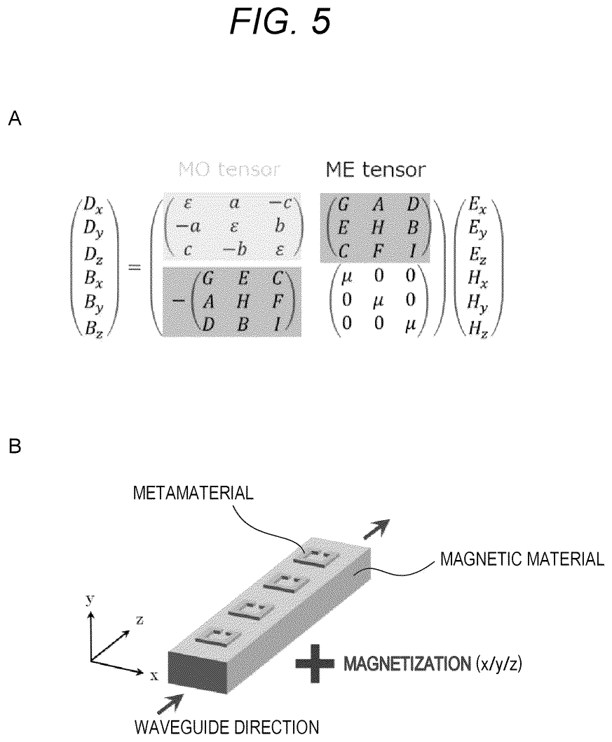

Therefore, the inventors have developed a wave control device according to the present technology as a wave control device capable of freely controlling both the MO tensor and the ME tensor (see FIG. 5A) by effectively combining (see, for example, FIG. 5B, details of which will be described later.) controlling the MO tensor (specifically, the non-diagonal components of the MO tensor) by the magnetization direction of the magnetic material (see, for example, FIGS. 3A to 3C) and controlling the ME tensor (specifically, the diagonal components and the non-diagonal components of the ME tensor) by the arrangement of the metamaterial (see, for example, FIGS. 4A to 4F).

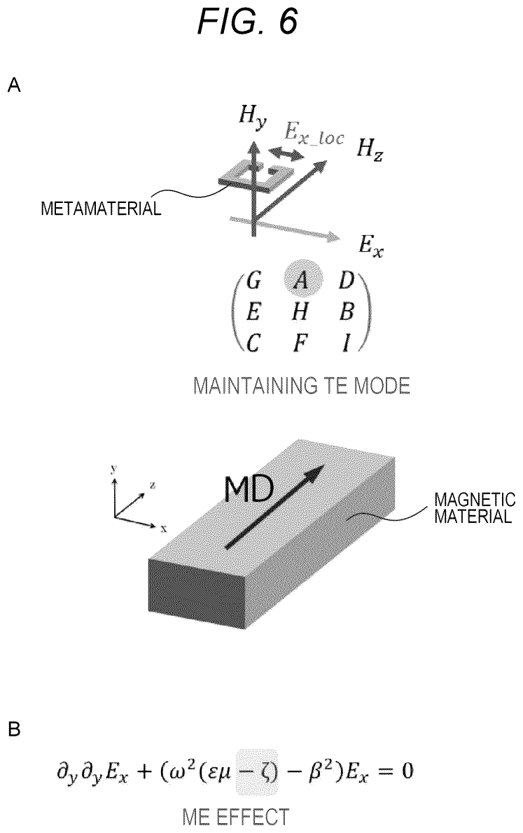

To supplement, by a combination of the magnetization direction MD of the magnetic material and the arrangement of the metamaterial as illustrated in FIG. 6A, the electromagnetic wave guided in the TE mode can be controlled while being mode-matched (while maintaining the TE mode). In the example illustrated in FIG. 6A, as illustrated in FIG. 6B, the term of the ME effect appears in a wave equation of the electromagnetic wave to be controlled, but the term of the MO effect does not appear. This means that in the example illustrated in FIG. 6A, the ME tensor can be controlled, but the MO tensor cannot be controlled.

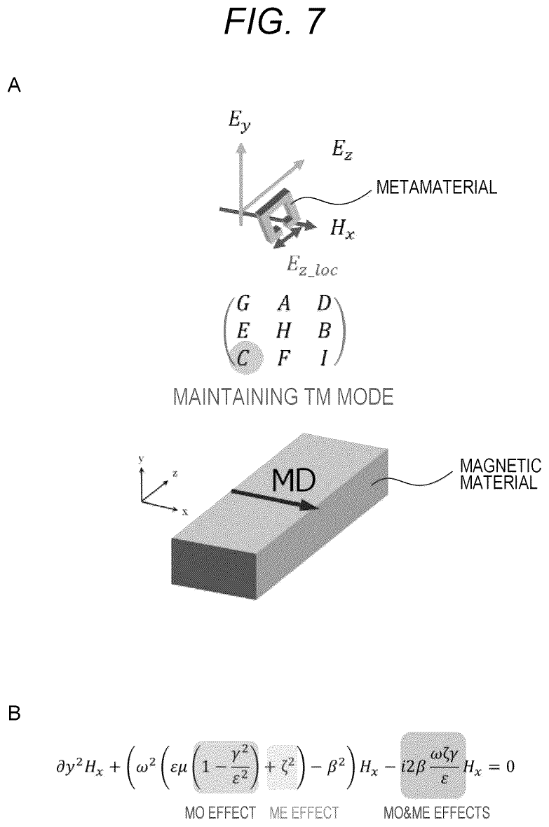

On the other hand, for example, by a combination of the magnetization direction MD of the magnetic material and the arrangement of the metamaterial as illustrated in FIG. 7A, it is possible to control the electromagnetic wave guided in the TM mode while performing mode matching (while maintaining the TM mode). In the example illustrated in FIG. 7A, as illustrated in FIG. 7B, the term of the MO effect and the term of the ME effect, and the term of the interaction between the MO effect and the ME effect appear in a wave equation of the electromagnetic wave to be controlled. This means that both the MO tensor and the ME tensor can be freely controlled in the example illustrated in FIG. 7A.

### 1. Wave Control Device According to First Embodiment of Present Technology

### (Configuration of Wave Control Device)

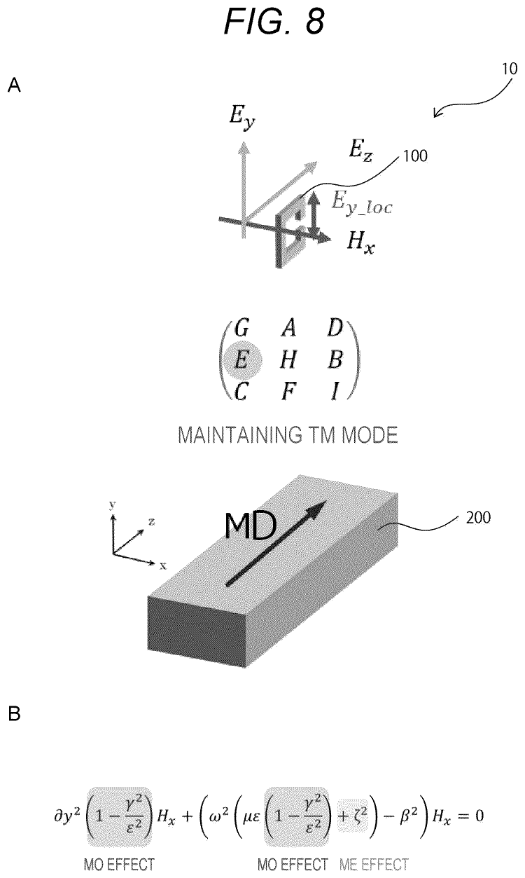

Hereinafter, a wave control device according to a first embodiment of the present technology will be described with reference to the drawings. FIG. 8A is a conceptual diagram of a wave control device 10 according to the first embodiment. FIG. 8B is a diagram illustrating a wave equation of an electromagnetic wave controlled by the wave control device 10 according to the first embodiment. Hereinafter, a description will be given appropriately using an xyz three-dimensional orthogonal coordinate system (for example, a left-handed coordinate system) illustrated in FIG. 8A.

As illustrated in FIG. 8A as an example, the wave control device 10 according to the first embodiment includes a metamaterial 100 and a magnetic material 200.

In the wave control device 10, as an example, the metamaterial 100 is disposed and the magnetization direction MD of the magnetic material 200 is set so that an electromagnetic effect and a magneto-optical effect occur with respect to an electromagnetic wave.

The magnetization direction of the magnetic material 200 may be set by an external magnetic field. In this case, the magnetization direction of the magnetic material 200 can be set according to an application direction of the external magnetic field.

The metamaterial 100 may be provided around a waveguide of the electromagnetic wave. In this case, the metamaterial 100 may be provided integrally with the waveguide of the electromagnetic wave. In this case, in particular, two-dimensional (planar) metamaterial 100 can be formed on a configuration element (core or cladding) of the waveguide by using, for example, a photolithography method, a vapor deposition method, a sputtering method, or the like.

The core of the waveguide of the electromagnetic wave may be the magnetic material 200. That is, the magnetic material 200 may be made of a material that propagates and emits an incident electromagnetic wave to be controlled while totally reflecting the electromagnetic wave. In a case where the core is the magnetic material 200, the metamaterial 100 may be provided on an outer surface (e.g., a side surface) of the core. The magnetic material 200 constituting the core is preferably transparent to a wavelength of the electromagnetic wave (for example, transparent ferromagnetic) in order to guide the electromagnetic wave to be controlled. Note that, in the present specification, a surface other than a surface (incident end surface) constituting an incident end and a surface (emission end surface) constituting an emission end of the electromagnetic wave in the outer surface of the core is referred to as a side surface of the core.

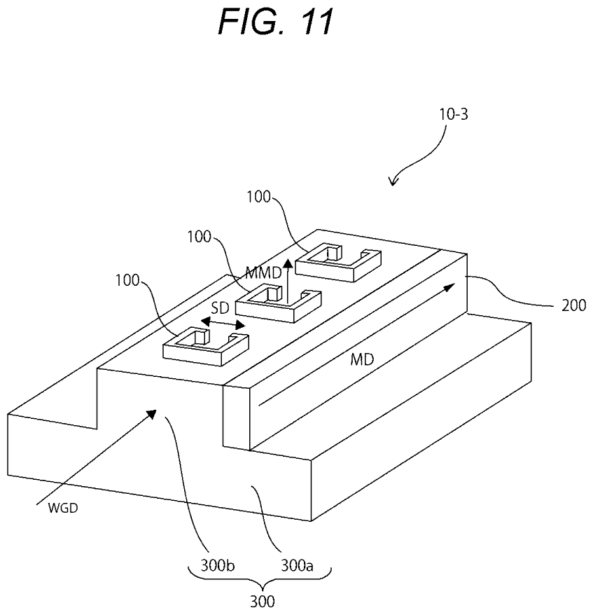

The wave control device 10 may further include a waveguide member 300 (see FIG. 11) including a core of the waveguide of an electromagnetic wave. In this case, the metamaterial 100 and the magnetic material 200 may be provided on an outer surface (for example, a side surface) of the core.

The metamaterial 100 includes, as an example, a split-ring resonator (SSR). In the wave control device 10, a magnetic moment direction (substantially x-axis direction) of the split-ring resonator as the metamaterial 100 is substantially perpendicular to a waveguide direction (substantially z-axis direction) of the electromagnetic wave, and the magnetic moment direction (substantially x-axis direction) of the split-ring resonator is substantially perpendicular to a magnetization direction (substantially z-axis direction) of the magnetic material. Moreover, in the wave control device 10, a split direction (break direction, substantially y-axis direction, and direction in which end portions are opposed to each other) of the split-ring resonator as the metamaterial 100 is substantially perpendicular to both the waveguide direction (substantially z-axis direction) of the electromagnetic wave and the magnetization direction (substantially z-axis direction) of the magnetic material. Note that, in the present specification, “substantially” includes a case where there is complete agreement and a case where there is a slight difference in the same range of effects.

### (Operation of Wave Control Device)

The wave control device 10 can control the electromagnetic wave guided in the TM mode while performing mode matching (while maintaining the TM mode) by a combination of the arrangement of such the metamaterial 100 and the magnetization direction MD of the magnetic material 200. Moreover, the wave equation of the electromagnetic wave controlled by the wave control device 10 is expressed by the following Formula (1) (see FIG. 8B), and it can be seen that both the MO effect and the ME effect are exhibited.

$$\partial {y}^{2} ( 1 - {γ}^{2} / {ε}^{2} ) {H}_{x} + [ {ω}^{2} ( μ ε ( 1 - {γ}^{2} / {ε}^{2} ) + {ζ}^{2} ) - {β}^{2} ) ] {H}_{x} = 0 \qquad ( 1 )$$

where ε is a dielectric constant, μ is a magnetic permeability, ω is an angular frequency, γ is a parameter related to the MO effect, ζ is a parameter related to the ME effect, and β is a propagation constant (the similarity applies hereinafter). Furthermore, here, it is assumed that iγ is input to a that is an element related to the MO effect, and that ζ is input to E that is an element related to the ME effect.

### (Details of Metamaterial)

The split-ring resonator as the metamaterial 100 is formed of, for example, a thin wire made of a material selected from any one of a metal, a dielectric, a conductive magnetic body, a semiconductor, and a superconductor, or a combination of a plurality of these. An outer diameter of the split-ring resonator is preferably, for example, about 1/100 to ½ of the wavelength of the electromagnetic wave. A wire diameter of the split-ring resonator is preferably, for example, 1/1000 to 1/100 of the wavelength of the electromagnetic wave, and more preferably 1/1000 to 1/10.

### (Details of Magnetic Material)

As the magnetic material 200, for example, iron, nickel, cobalt, magnetic garnet, iron oxide, chromium oxide, ferrite, a non-oxide metal magnetic material (oxide), or the like can be used. Note that these are examples of the magnetic material 200, and the magnetic material 200 may be another magnetic material. In the example illustrated in FIG. 8, the magnetic material having a rectangular parallelepiped shape is illustrated, but the size, shape, and the like of the magnetic material are not limited, and can be appropriately changed.

### (Details of Waveguide Member)

As a material of the waveguide member 300, for example, an inorganic material such as quartz glass or silicon, or an organic material such as a polyimide-based resin, a polyamide-based resin, or a polyether-based resin can be used. The material of the waveguide member 300 is preferably selected in consideration of transmittance, refractive index, wavelength characteristics, dispersibility, and the like of the electromagnetic wave to be controlled.

Hereinafter, some examples (more specific concepts) of the wave control device 10 according to the first embodiment of the present technology will be described.

### (Wave Control Medium According to Example 1)

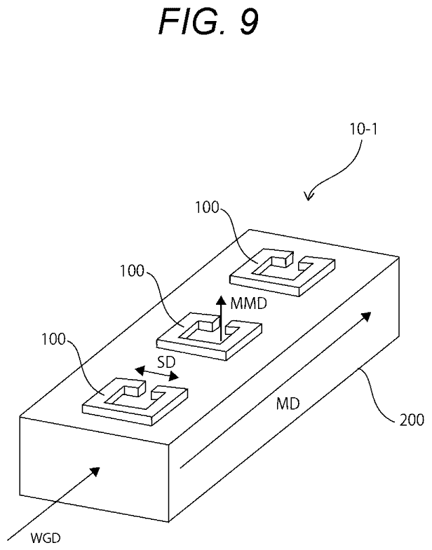

In a wave control device 10-1 according to Example 1, as illustrated in FIG. 9, a core of a waveguide of an electromagnetic wave to be controlled is a magnetic material 200. In the wave control device 10-1, a metamaterial 100 is provided on one outer surface (for example, a side surface having a larger area) of the magnetic material 200 as the core. Here, a plurality of the metamaterials 100 are regularly (for example, at equal intervals) provided substantially parallel to a waveguide direction WGD (a longitudinal direction of the magnetic material 200) of the electromagnetic wave to be controlled.

In the wave control device 10-1, a magnetic moment direction MMD of a split-ring resonator as the metamaterial 100 is substantially perpendicular to the waveguide direction WGD of the electromagnetic wave, and the magnetic moment direction MMD of the split-ring resonator is substantially perpendicular to a magnetization direction MD of the magnetic material. Moreover, in the wave control device 10-1, a split direction SD (break direction) of the split-ring resonator is substantially perpendicular to both the waveguide direction WGD of the electromagnetic wave and the magnetization direction MD of the magnetic material 200.

### (Wave Control Medium According to Example 2)

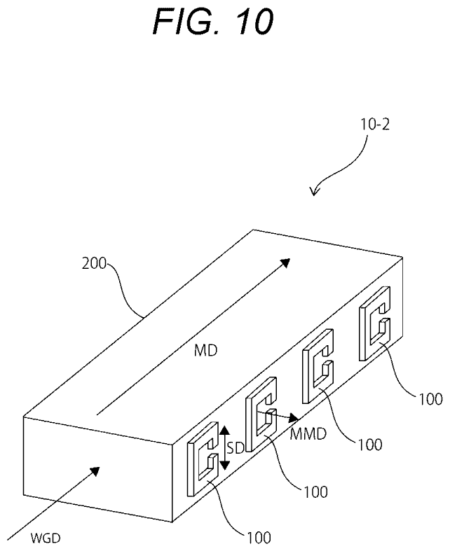

As illustrated in FIG. 10, a wave control device 10-2 according to Example 2 has a configuration substantially similar to the wave control device 10-1 according to Example 1 except that a metamaterial 100 is provided on another outer surface (for example, a side surface having a smaller area) of a magnetic material 200 as a core.

Also in the wave control device 10-2, a split direction SD (break direction) of a split-ring resonator as the metamaterial 100 is substantially perpendicular to both a waveguide direction WGD of an electromagnetic wave and a magnetization direction MD of the magnetic material 200.

### (Wave Control Medium According to Example 3)

As illustrated in FIG. 11, a wave control device 10-3 according to Example 3 further includes a waveguide member 300 including a core 300b of a waveguide of an electromagnetic wave. As an example, the waveguide member 300 includes a base portion 300a in addition to the core 300b. In the waveguide member 300, the core 300b that is a ridge is provided on the base portion 300a having a flat plate shape.

A metamaterial 100 is provided on an upper surface of the core 300b, and a magnetic material 200 is provided on one side surface of the core 300b. Here, a plurality of the metamaterials 100 are regularly (for example, at equal intervals) provided substantially parallel to a waveguide direction WGD (a longitudinal direction of the magnetic material 200) of the electromagnetic wave to be controlled.

The waveguide member 300 is molded by processing a substrate (for example, Si substrate) or the like transparent to a wavelength of the electromagnetic wave in order to guide the electromagnetic wave to be controlled. The metamaterial 100 may be made of Au, for example, and the magnetic material 200 may be made of Yttrium Iron Garnet (YIG), for example.

In the wave control device 10-3, a magnetic moment direction MMD of a split-ring resonator as the metamaterial 100 is substantially perpendicular to the waveguide direction WGD of the electromagnetic wave, and the magnetic moment direction MMD of the split-ring resonator is substantially perpendicular to a magnetization direction MD of the magnetic material. Moreover, in the wave control device 10-3, a split direction SD (break direction) of the split-ring resonator is substantially perpendicular to both the waveguide direction WGD of the electromagnetic wave and the magnetization direction MD of the magnetic material 200.

### (Wave Control Device According to Example 4)

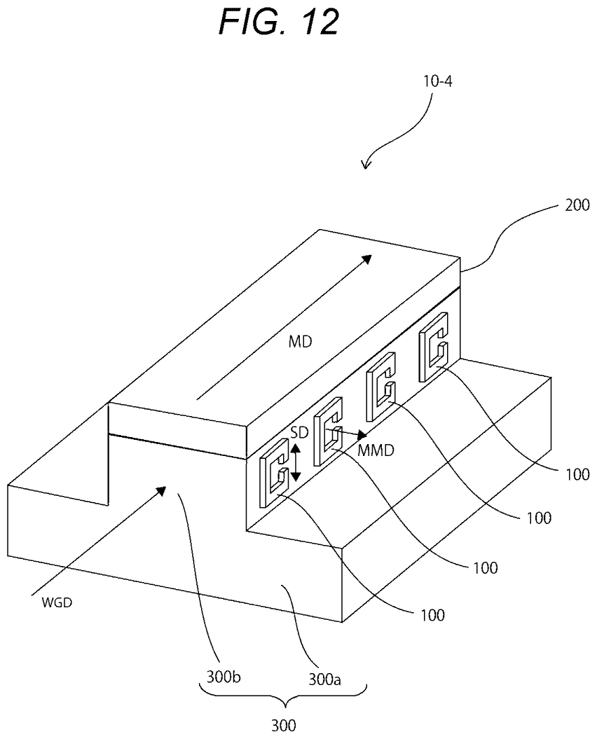

As illustrated in FIG. 12, a wave control device 10-4 according to Example 4 has a configuration substantially similar to the wave control device 10-3 according to Example 3 except that a metamaterial 100 is provided on a side surface of a core 300b and a magnetic material 200 is provided on an upper surface of the core 300b.

Also in the wave control device 10-4, a split direction SD (break direction) of a split-ring resonator as the metamaterial 100 is substantially perpendicular to both a waveguide direction WGD of an electromagnetic wave and a magnetization direction MD of the magnetic material 200.

### (Wave Control Medium According to Example 5)

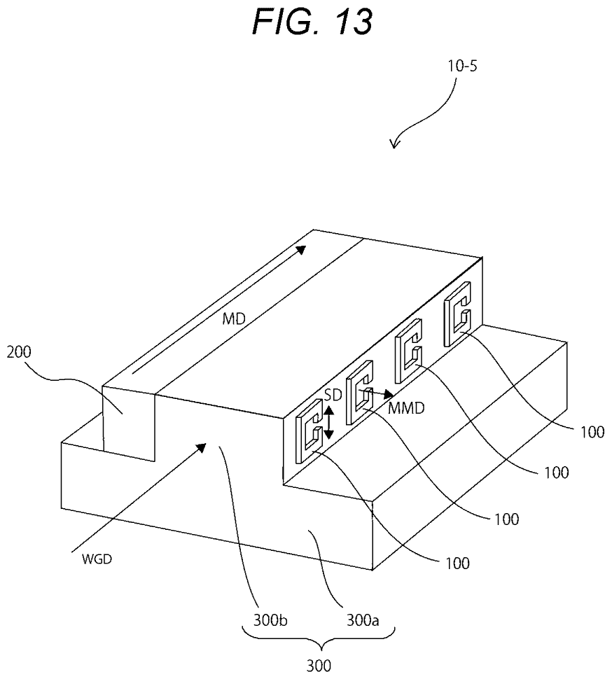

As illustrated in FIG. 13, a wave control device 10-5 according to Example 5 has a configuration substantially similar to the wave control device 10-3 according to Example 3 except that a metamaterial 100 is provided on one side surface out of one side surface and the other side surface facing each other of a core 300b and a magnetic material 200 is provided on the other side surface.

Also in the wave control device 10-5, a split direction SD (break direction) of a split-ring resonator as the metamaterial 100 is substantially perpendicular to both a waveguide direction WGD of an electromagnetic wave and a magnetization direction MD of the magnetic material 200.

### (Effect of Wave Control Device)

The wave control device 10 according to the first embodiment includes the metamaterial 100 and the magnetic material 200. In this case, the controllability of the electromagnetic wave can be improved by effectively combining the arrangement of the metamaterial 100 and the magnetization direction of the magnetic material 200.

It is preferable that the metamaterial 100 is disposed and the magnetization direction MD of the magnetic material 200 is set such that at least the electromagnetic effect and the magneto-optical effect occur with respect to the electromagnetic wave. As a result, the controllability of the electromagnetic wave can be reliably improved.

The metamaterial 100 is preferably disposed around the waveguide of the electromagnetic wave. Thus, a control action of the metamaterial 100 can be exerted on the electromagnetic wave.

The metamaterial 100 is preferably provided integrally with the waveguide of the electromagnetic wave. As a result, a positional relationship between the metamaterial 100 and the waveguide of the electromagnetic wave can be maintained at a desired (effective) positional relationship.

The core of the waveguide of the electromagnetic wave may be the magnetic material 200. As a result, since the magnetic material 200 also serves as a core, it is possible to reduce the number of components and downsize.

The metamaterial 100 may be provided on an outer surface of the magnetic material 200 as a core. As a result, the metamaterial 100 can be stably disposed at a position where a control action can be sufficiently exerted on the electromagnetic wave.

The wave control device 10 may further include the waveguide member 300 including the core 300b of the waveguide of the electromagnetic wave. As a result, since the core 300b is provided separately from the magnetic material 200, the degree of freedom in selecting the material of the magnetic material 200 can be improved.

The metamaterial 100 and the magnetic material 200 may be provided on the outer surface of the core of the waveguide member 300. As a result, the metamaterial 100 and the magnetic material 200 can be stably disposed at a position where a control action can be sufficiently exerted on the electromagnetic wave.

The metamaterial 100 includes the split-ring resonator, and it is preferable that the magnetic moment direction MMD of the split-ring resonator and the waveguide direction WGD of the electromagnetic wave are substantially perpendicular, and the magnetic moment direction MMD and the magnetization direction MD of the magnetic material 200 are substantially perpendicular. As a result, the control action of the metamaterial 100 and the magnetic material 200 can be exerted on the electromagnetic wave.

More preferably, the split direction SD (break direction) of the split-ring resonator as the metamaterial 100 is substantially perpendicular to both the waveguide direction WGD and the magnetization direction MD. As a result, the control action of the metamaterial 100 and the magnetic material 200 can be reliably exerted on the electromagnetic wave.

The electromagnetic wave to be controlled by the wave control device 10 is preferably guided in the TM mode. As a result, the wave control device 10 can reliably generate the MO effect on the electromagnetic wave.

The magnetization direction MD of the magnetic material 200 may be set by an external magnetic field. As a result, the magnetization direction MD can be stably maintained in a desired direction.

### 2. Wave Control Device According to Second Embodiment of Present Technology

### (Configuration of Wave Control Device)

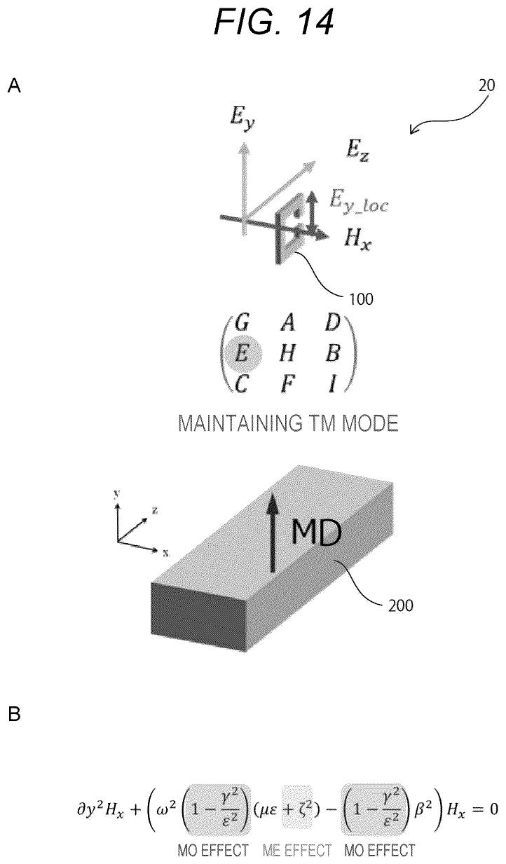

Hereinafter, a wave control device according to a second embodiment of the present technology will be described with reference to the drawings. FIG. 14A is a conceptual diagram of a wave control device 20 according to the first embodiment. FIG. 14B is a diagram illustrating a wave equation of an electromagnetic wave controlled by the wave control device 20 according to the second embodiment. Hereinafter, a description will be given appropriately using an xyz three-dimensional orthogonal coordinate system (for example, a left-handed coordinate system) illustrated in FIG. 14A.

In the wave control device 20 according to the second embodiment, as illustrated in FIG. 14A as an example, a magnetic moment direction (substantially x-axis direction) of a split-ring resonator as a metamaterial 100 is substantially perpendicular to a waveguide direction (substantially z-axis direction) of an electromagnetic wave, and the magnetic moment direction (substantially x-axis direction) of the split-ring resonator is substantially perpendicular to a magnetization direction (substantially y-axis direction) of a magnetic material. Moreover, in the wave control device 20, a split direction (break direction, substantially y-axis direction) of the split-ring resonator as the metamaterial 100 is substantially perpendicular to the waveguide direction (substantially z-axis direction) of the electromagnetic wave and substantially parallel to the magnetization direction MD (substantially y-axis direction) of the magnetic material 200.

### (Operation of Wave Control Device)

The wave control device 20 can control the electromagnetic wave guided in the TM mode while performing mode matching (while maintaining the TM mode) by a combination of the arrangement of such the metamaterial 100 and the magnetization direction MD of the magnetic material 200. Moreover, the wave equation of the electromagnetic wave controlled by the wave control device 20 is expressed by the following Formula (2) (see FIG. 14B), and it can be seen that both the MO effect and the ME effect are exhibited.

$$\partial {y}^{2} {H}_{x} + [ {ω}^{2} ( 1 - {γ}^{2} / {ε}^{2} ) ( μ ε + {ζ}^{2} ) - ( 1 - {γ}^{2} / {ε}^{2} ) {β}^{2} ) ] {H}_{x} = 0 \qquad ( 2 )$$

Here, it is assumed that iγ is input to c that is an element related to the MO effect, and that ζ is input to E that is an element related to the ME effect.

### (Effect of Wave Control Device)

According to the wave control device 20 according to the second embodiment, effects similar to those of the wave control device 10 according to the first embodiment can be obtained.

Hereinafter, some examples (more specific concepts) of the wave control device 20 according to the second embodiment of the present technology will be described.

### (Wave Control Medium According to Example 1)

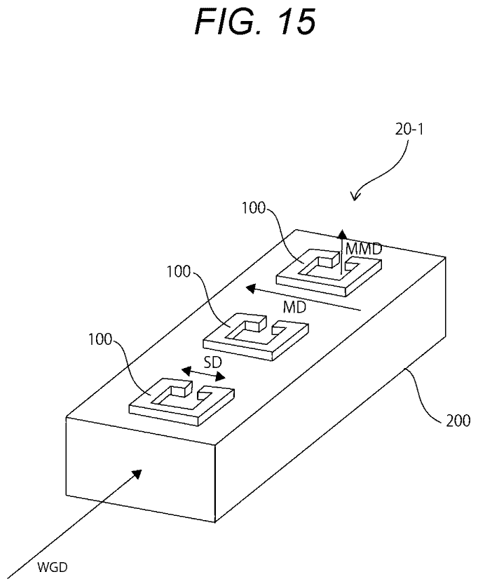

In a wave control device 20-1 according to Example 1, as illustrated in FIG. 15, a core of a waveguide of an electromagnetic wave is a magnetic material 200. In the wave control device 20-1, a metamaterial 100 is provided on an outer surface (for example, a side surface having a larger area) of the magnetic material 200 as a core. Here, a plurality of the metamaterials 100 are regularly (for example, at equal intervals) provided substantially parallel to a waveguide direction WGD (a longitudinal direction of the magnetic material 200) of the electromagnetic wave to be controlled.

In the wave control device 20-1, a magnetic moment direction MMD of a split-ring resonator as the metamaterial 100 is substantially perpendicular to a waveguide direction WGD of the electromagnetic wave, and the magnetic moment direction MMD of the split-ring resonator is substantially perpendicular to a magnetization direction MD of the magnetic material 200. Moreover, in the wave control device 20-1, a split direction SD (break direction) of the split-ring resonator as the metamaterial 100 is substantially perpendicular to the waveguide direction WGD of the electromagnetic wave and substantially parallel to the magnetization direction MD of the magnetic material 200.

### (Wave Control Medium According to Example 2)

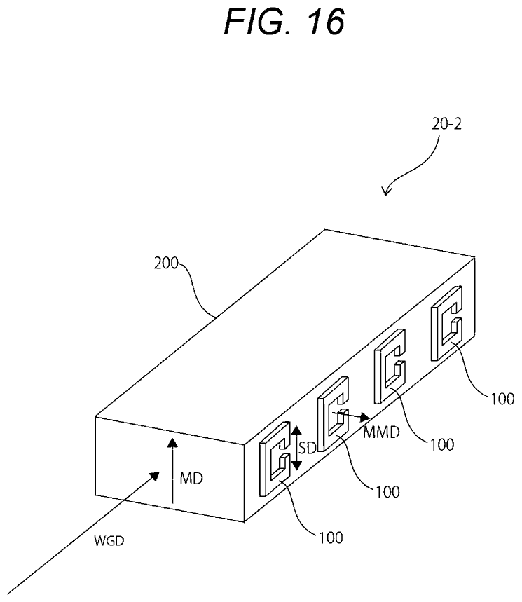

As illustrated in FIG. 16, a wave control device 20-2 according to Example 2 has a configuration substantially similar to the wave control device 20-1 according to Example 1 except that a metamaterial 100 is provided on another outer surface (for example, a side surface having a smaller area) of a magnetic material 200 as a core.

Also in the wave control device 20-2, a split direction SD (break direction) of a split-ring resonator as the metamaterial 100 is substantially perpendicular to a waveguide direction WGD of the electromagnetic wave and substantially parallel to a magnetization direction MD of the magnetic material 200.

### (Wave Control Medium According to Example 3)

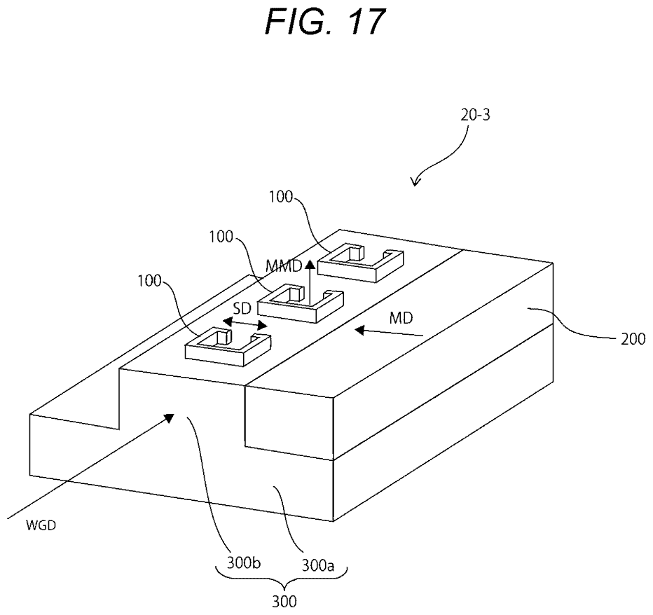

As illustrated in FIG. 17, in a wave control device 20-3 according to Example 3, the wave control device 20-3 further includes a waveguide member 300 including a core 300b of a waveguide of an electromagnetic wave. As an example, the waveguide member 300 includes a base portion 300a in addition to the core 300b. In the waveguide member 300, the core 300b that is a ridge is provided on the base portion 300a having a flat plate shape.

A metamaterial 100 is provided on an upper surface of the core 300b, and a magnetic material 200 is provided on one side surface of the core 300b. Here, a plurality of the metamaterials 100 are regularly (for example, at equal intervals) provided substantially parallel to a waveguide direction WGD (a longitudinal direction of the magnetic material 200) of the electromagnetic wave to be controlled.

The waveguide member 300 is molded by processing a substrate (for example, Si substrate) or the like transparent to a wavelength of the electromagnetic wave in order to guide the electromagnetic wave to be controlled. As the metamaterial 100, for example, one made of Au can be used, and as the magnetic material 200, for example, one made of YIG can be used.

In the wave control device 20-3, a magnetic moment direction MMD of a split-ring resonator as the metamaterial 100 is substantially perpendicular to a waveguide direction WGD of the electromagnetic wave, and the magnetic moment direction MMD of the split-ring resonator is substantially perpendicular to a magnetization direction MD of the magnetic material 200. Moreover, in the wave control device 20-3, a split direction SD (break direction) of the split-ring resonator as the metamaterial 100 is substantially perpendicular to the waveguide direction WGD of the electromagnetic wave and substantially parallel to the magnetization direction MD of the magnetic material 200.

### (Wave Control Device According to Example 4)

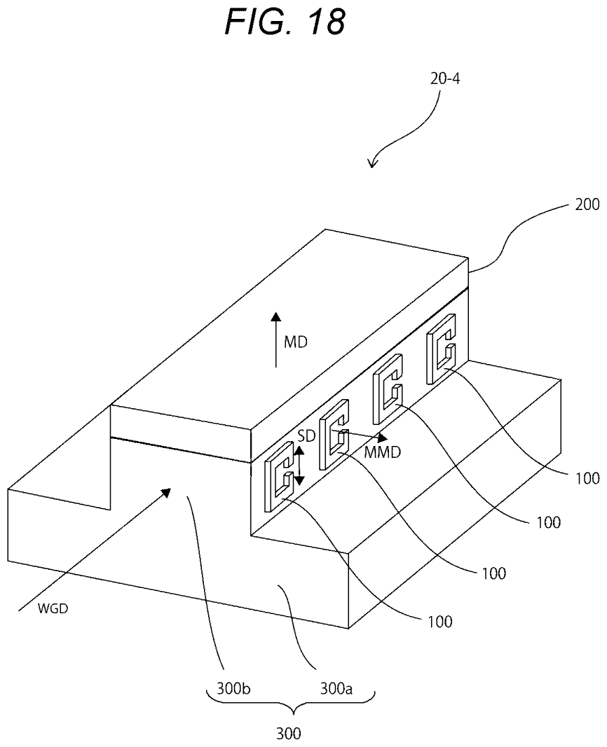

As illustrated in FIG. 18, a wave control device 10-4 according to Example 4 has a configuration substantially similar to the wave control device 20-3 according to Example 3 except that a metamaterial 100 is provided on a side surface of a core 300b and a magnetic material 200 is provided on an upper surface of the core 300b.

Also in the wave control device 20-4, a split direction SD (break direction) of a split-ring resonator as the metamaterial 100 is substantially perpendicular to a waveguide direction WGD of an electromagnetic wave and substantially parallel to a magnetization direction MD of the magnetic material 200.

### (Wave Control Medium According to Example 5)

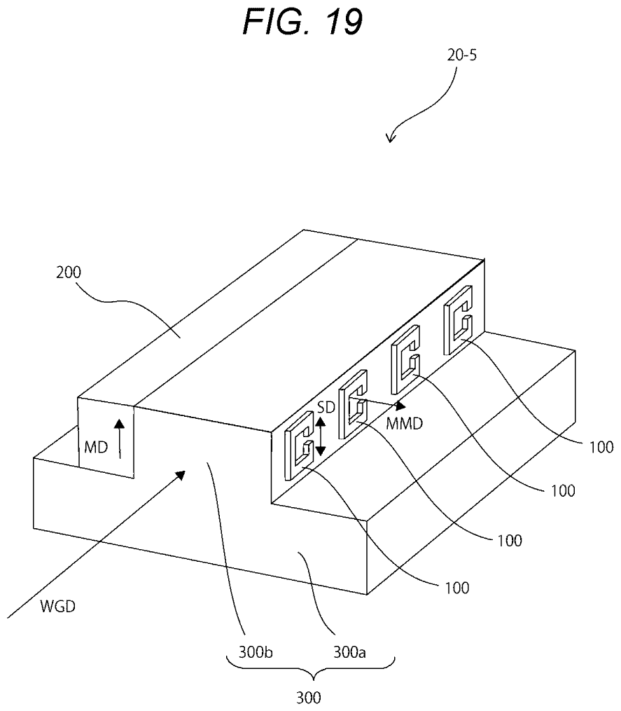

As illustrated in FIG. 19, a wave control device 20-5 according to Example 5 has a configuration substantially similar to the wave control device 20-3 according to Example 3 except that a metamaterial 100 is provided on one side surface out of one side surface and the other side surface facing each other of a core 300b and a magnetic material 200 is provided on the other side surface.

Also in the wave control device 20-5, a split direction SD (break direction) of a split-ring resonator as the metamaterial 100 is substantially perpendicular to a waveguide direction WGD of an electromagnetic wave and substantially parallel to a magnetization direction MD of the magnetic material 200.

### 3. Wave Control Device According to Third Embodiment of Present Technology

### (Configuration of Wave Control Device)

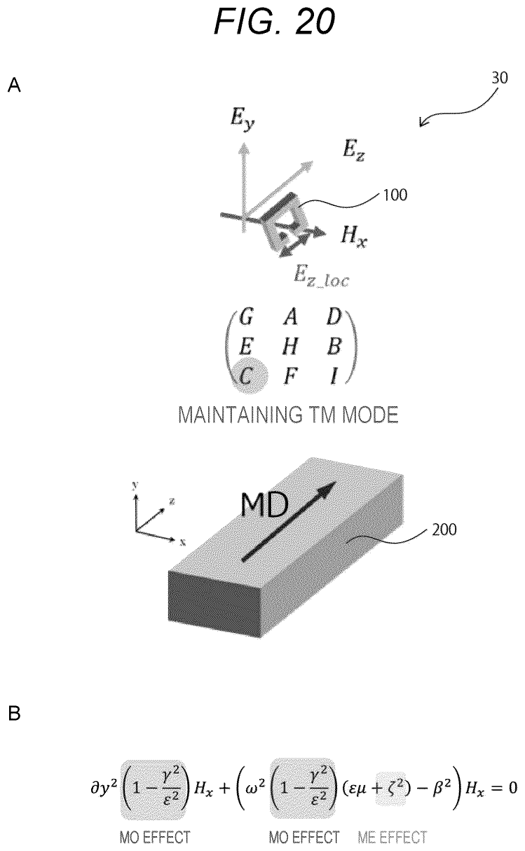

Hereinafter, a wave control device according to a third embodiment of the present technology will be described with reference to the drawings. FIG. 20A is a conceptual diagram of a wave control device 30 according to a third embodiment. FIG. 20B is a diagram illustrating a wave equation of an electromagnetic wave controlled by the wave control device 30 according to the third embodiment. Hereinafter, a description will be given appropriately using an xyz three-dimensional orthogonal coordinate system (for example, a left-handed coordinate system) illustrated in FIG. 20A.

In the wave control device 30 according to the third embodiment, as an example, as illustrated in FIG. 20A, a magnetic moment direction (substantially x-axis direction) of a split-ring resonator as a metamaterial 100 is substantially perpendicular to a waveguide direction (substantially z-axis direction) of an electromagnetic wave, and the magnetic moment direction (substantially x-axis direction) of the split-ring resonator is substantially perpendicular to a magnetization direction (substantially z-axis direction) of a magnetic material. Moreover, in the wave control device 30, the split direction (break direction, substantially z-axis direction) of the split-ring resonator as the metamaterial 100 is substantially parallel to both the waveguide direction (substantially z-axis direction) of the electromagnetic wave and the magnetization direction MD (substantially z-axis direction) of the magnetic material 200.

### (Operation of Wave Control Device)

The wave control device 30 can control the electromagnetic wave guided in the TM mode while performing mode matching (while maintaining the TM mode) by a combination of the arrangement of such the metamaterial 100 and the magnetization direction of the magnetic material 200. Moreover, the wave equation of the electromagnetic wave controlled by the wave control device 20 is expressed by the following Formula (3) (see FIG. 20B), and it can be seen that both the MO effect and the ME effect are exhibited.

$$\partial {y}^{2} ( 1 - {γ}^{2} / {ε}^{2} ) {H}_{x} + [ {ω}^{2} ( 1 - {γ}^{2} / {ε}^{2} ) ( μ ε + {ζ}^{2} ) - {β}^{2} ) ] {H}_{x} = 0 \qquad ( 3 )$$

Here, it is assumed that iγ is input to a that is an element related to the MO effect, and that ζ is input to C that is an element related to the ME effect.

### (Effect of Wave Control Device)

According to the wave control device 30 according to the third embodiment, it is possible to obtain an effect similar to that of the wave control device 10 according to the first embodiment.

Hereinafter, some examples (more specific concepts) of the wave control device 20 according to the second embodiment of the present technology will be described.

### (Wave Control Medium According to Example 1)

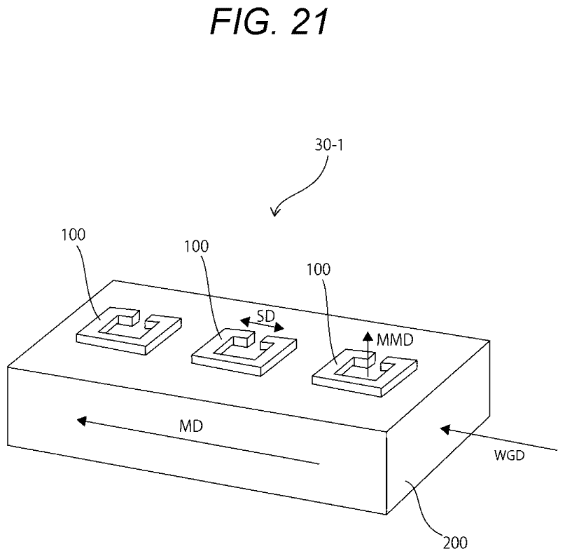

In a wave control device 30-1 according to Example 1, as illustrated in FIG. 21, a core of a waveguide of an electromagnetic wave is a magnetic material 200. In the wave control device 30-1, a metamaterial 100 is provided on an outer surface (for example, a side surface having a larger area) of the magnetic material 200 as a core. Here, a plurality of the metamaterials 100 are regularly (for example, at equal intervals) provided substantially parallel to a waveguide direction WGD (a longitudinal direction of the magnetic material 200) of the electromagnetic wave to be controlled.

In the wave control device 30-1, a magnetic moment direction MMD of a split-ring resonator as the metamaterial 100 is substantially perpendicular to the waveguide direction WGD of the electromagnetic wave, and the magnetic moment direction MMD of the split-ring resonator is substantially perpendicular to a magnetization direction MD of the magnetic material 200. Moreover, in the wave control device 30-1, a split direction SD (break direction) of the split-ring resonator as the metamaterial 100 is substantially parallel to both the waveguide direction WGD of the electromagnetic wave and the magnetization direction MD of the magnetic material 200.

### (Wave Control Medium According to Example 2)

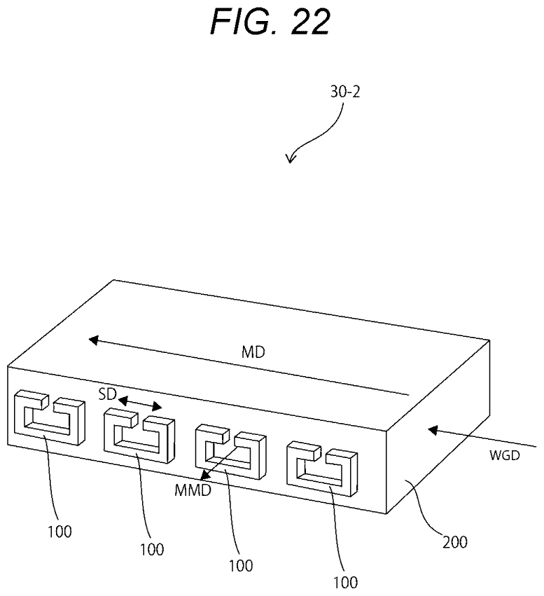

As illustrated in FIG. 22, a wave control device 30-2 according to Example 2 has a configuration substantially similar to the wave control device 30-1 according to Example 1 except that a metamaterial 100 is provided on another outer surface (for example, a side surface having a smaller area) of a magnetic material 200 as a core.

Also in the wave control device 30-2, a split direction SD (break direction) of a split-ring resonator as the metamaterial 100 is substantially parallel to both a waveguide direction WGD of an electromagnetic wave and a magnetization direction MD of the magnetic material 200.

### (Wave Control Medium According to Example 3)

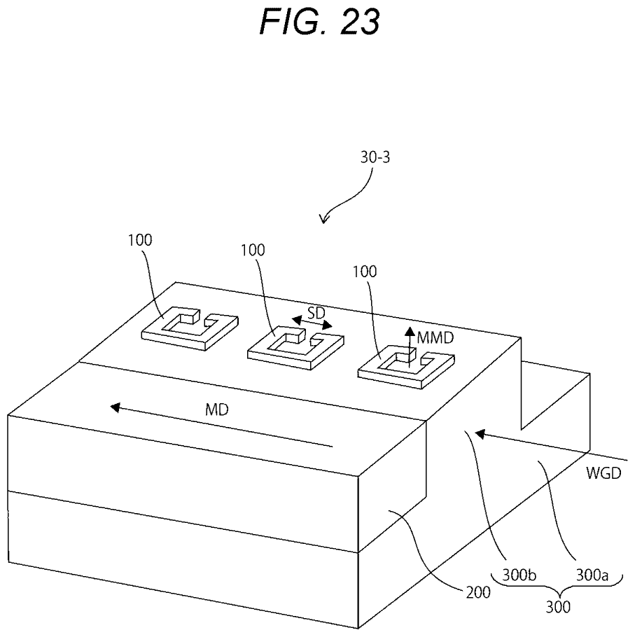

As illustrated in FIG. 23, in a wave control device 30-3 according to Example 3, the wave control device 30-3 further includes a waveguide member 300 including a core 300b of a waveguide of an electromagnetic wave. As an example, the waveguide member 300 includes a base portion 300a in addition to the core 300b. In the waveguide member 300, the core 300b that is a ridge is provided on the base portion 300a having a flat plate shape.

A metamaterial 100 is provided on an upper surface of the core 300b, and a magnetic material 200 is provided on one side surface of the core 300b. Here, a plurality of the metamaterials 100 are regularly (for example, at equal intervals) provided substantially parallel to a waveguide direction WGD (a longitudinal direction of the magnetic material 200) of the electromagnetic wave to be controlled.

The waveguide member 300 is molded by processing a substrate (for example, Si substrate) or the like transparent to a wavelength of the electromagnetic wave in order to guide the electromagnetic wave to be controlled. As the metamaterial 100, for example, one made of Au can be used, and as the magnetic material 200, for example, one made of YIG can be used.

In the wave control device 30-3, a magnetic moment direction MMD of a split-ring resonator as the metamaterial 100 is substantially perpendicular to the waveguide direction WGD of the electromagnetic wave, and the magnetic moment direction MMD of the split-ring resonator is substantially perpendicular to a magnetization direction MD of the magnetic material 200. Moreover, in the wave control device 30-3, a split direction SD (break direction) of the split-ring resonator as the metamaterial 100 is substantially parallel to both the waveguide direction WGD of the electromagnetic wave and the magnetization direction MD of the magnetic material 200.

### (Wave Control Device According to Example 4)

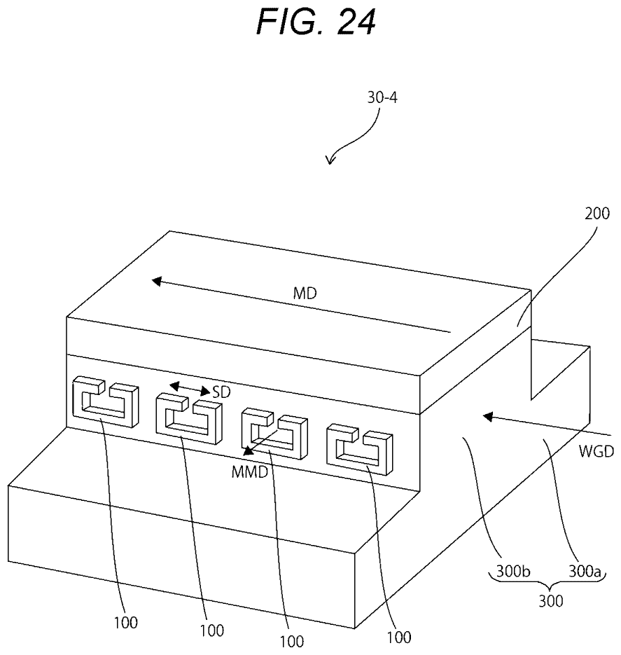

As illustrated in FIG. 24, a wave control device 30-4 according to Example 4 has a configuration substantially similar to the wave control device 30-3 according to Example 3 except that a metamaterial 100 is provided on a side surface of a core 300b and a magnetic material 200 is provided on an upper surface of the core 300b.

Also in the wave control device 30-4, a split direction SD (break direction) of a split-ring resonator as the metamaterial 100 is substantially parallel to both a waveguide direction WGD of an electromagnetic wave and a magnetization direction MD of the magnetic material 200.

(Wave control medium according to Example 5)

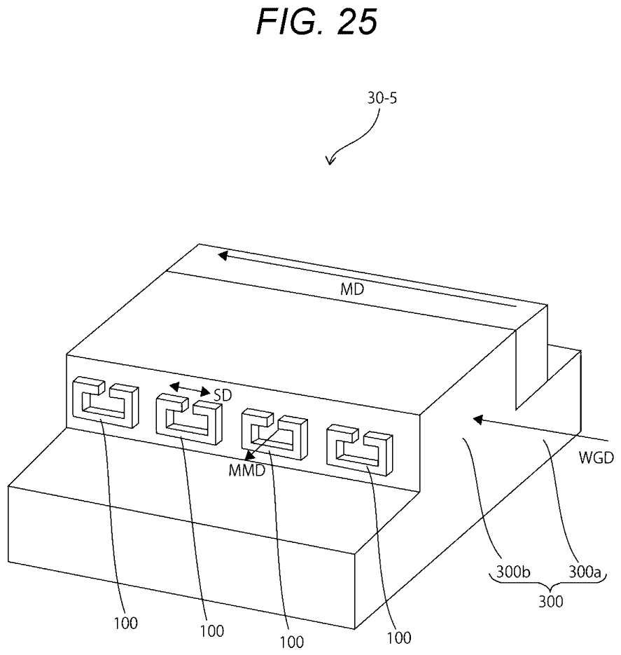

As illustrated in FIG. 25, a wave control device 30-5 according to Example 5 has a configuration substantially similar to the wave control device 30-3 according to Example 3 except that a metamaterial 100 is provided on one side surface out of one side surface and the other side surface facing each other of a core 300b and a magnetic material 200 is provided on the other side surface.

Also in the wave control device 30-5, a split direction SD (break direction) of a split-ring resonator as the metamaterial 100 is substantially parallel to both a waveguide direction WGD of an electromagnetic wave and a magnetization direction MD of the magnetic material 200.

### 4. Wave Control Device According to Fourth Embodiment of Present Technology

### (Configuration of Wave Control Device)

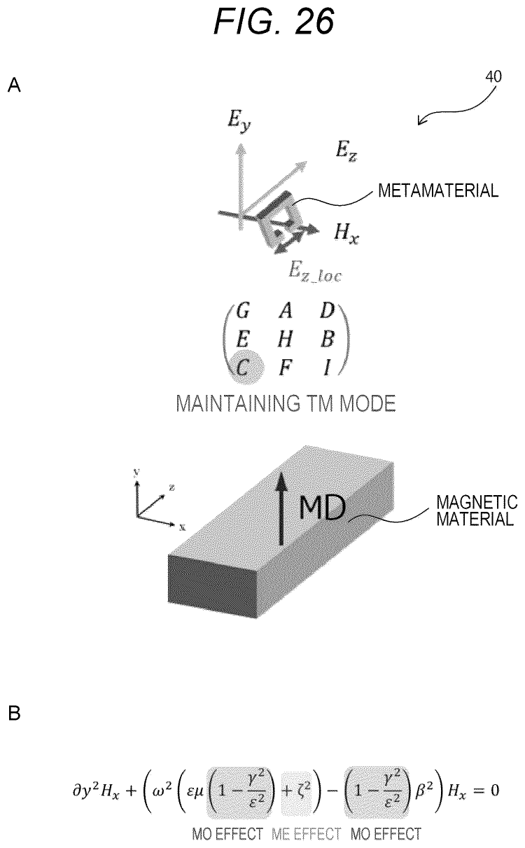

Hereinafter, a wave control device according to a fourth embodiment of the present technology will be described with reference to the drawings. FIG. 26A is a conceptual diagram of a wave control device 40 according to the fourth embodiment. FIG. 26B is a diagram illustrating a wave equation of an electromagnetic wave controlled by the wave control device 40 according to the fourth embodiment. Hereinafter, a description will be given appropriately using an xyz three-dimensional orthogonal coordinate system (for example, a left-handed coordinate system) illustrated in FIG. 26A.

In the wave control device 40 according to the fourth embodiment, as illustrated in FIG. 26A as an example, an axial direction (substantially x-axis direction) of a split-ring resonator as a metamaterial 100 is substantially perpendicular to a waveguide direction (substantially z-axis direction) of an electromagnetic wave, and a magnetic moment direction (substantially x-axis direction) of the split-ring resonator is substantially perpendicular to a magnetization direction MD (substantially y-axis direction) of a magnetic material. Moreover, in the wave control device 40, a split direction (break direction, substantially z-axis direction) of the split-ring resonator as the metamaterial 100 is substantially parallel to the waveguide direction (substantially z-axis direction) of the electromagnetic wave and substantially perpendicular to the magnetization direction MD (substantially y-axis direction) of the magnetic material 200.

### (Operation of Wave Control Device)

The wave control device 40 can control the electromagnetic wave guided in the TM mode while performing mode matching (while maintaining the TM mode) by a combination of the arrangement of such the metamaterial 100 and the magnetization direction of the magnetic material 200. Moreover, the wave equation of the electromagnetic wave controlled by the wave control device 20 is expressed by the following Formula (4) (see FIG. 26B), and it can be seen that both the MO effect and the ME effect are exhibited.

$$\partial {y}^{2} {H}_{x} + [ {ω}^{2} ( μ ε ( 1 - {γ}^{2} / {ε}^{2} ) + {ζ}^{2} ) - ( 1 - {γ}^{2} / {ε}^{2} ) {β}^{2} ) ] {H}_{x} = 0 \qquad ( 4 )$$

Here, it is assumed that iγ is input to c that is an element related to the MO effect, and that ζ is input to C that is an element related to the ME effect.

### (Effect of Wave Control Device)

According to the wave control device 40 according to the fourth embodiment, it is possible to obtain an effect similar to that of the wave control device 10 according to the first embodiment.

Hereinafter, some examples (more specific concepts) of the wave control device 20 according to the fourth embodiment of the present technology will be described.

### (Wave Control Medium According to Example 1)

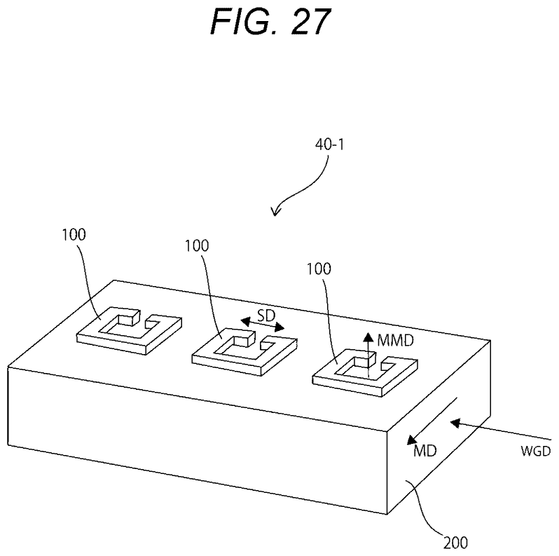

In a wave control device 40-1 according to Example 1, as illustrated in FIG. 27, a core of a waveguide of an electromagnetic wave is a magnetic material 200. In the wave control device 40-1, a metamaterial 100 is provided on an outer surface (for example, a side surface having a larger area) of the magnetic material 200 as a core. Here, a plurality of the metamaterials 100 are regularly (for example, at equal intervals) provided substantially parallel to a waveguide direction WGD (a longitudinal direction of the magnetic material 200) of the electromagnetic wave to be controlled.

In the wave control device 40-1, a magnetic moment direction MMD of a split-ring resonator as the metamaterial 100 is substantially perpendicular to the waveguide direction WGD of the electromagnetic wave, and the magnetic moment direction MMD of the split-ring resonator is substantially perpendicular to a magnetization direction MD of the magnetic material 200. Moreover, in the wave control device 40-1, a split direction SD (break direction) of the split-ring resonator as the metamaterial 100 is substantially parallel to the waveguide direction WGD of the electromagnetic wave and substantially perpendicular to the magnetization direction MD of the magnetic material 200.

(Wave control medium according to Example 2)

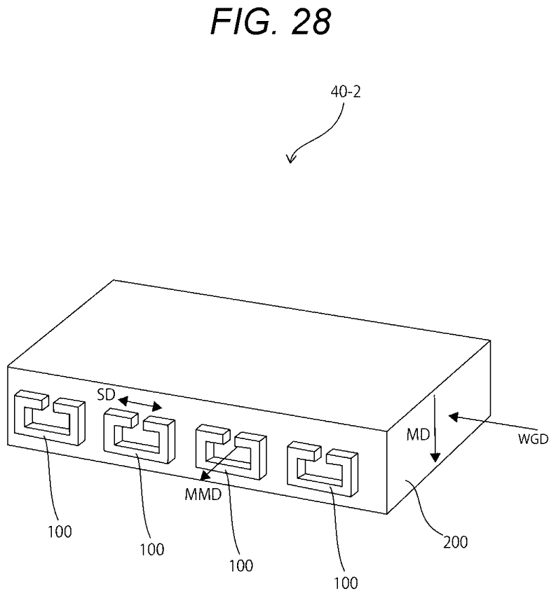

As illustrated in FIG. 28, a wave control device 40-2 according to Example 2 has a configuration substantially similar to the wave control device 40-1 according to Example 1 except that a metamaterial 100 is provided on another outer surface (for example, a side surface having a smaller area) of a magnetic material 200 as a core.

Also in the wave control device 40-2, a split direction SD (break direction) of a split-ring resonator as the metamaterial 100 is substantially parallel to a waveguide direction WGD of an electromagnetic wave and substantially perpendicular to a magnetization direction MD of the magnetic material 200.

(Wave control medium according to Example 3)

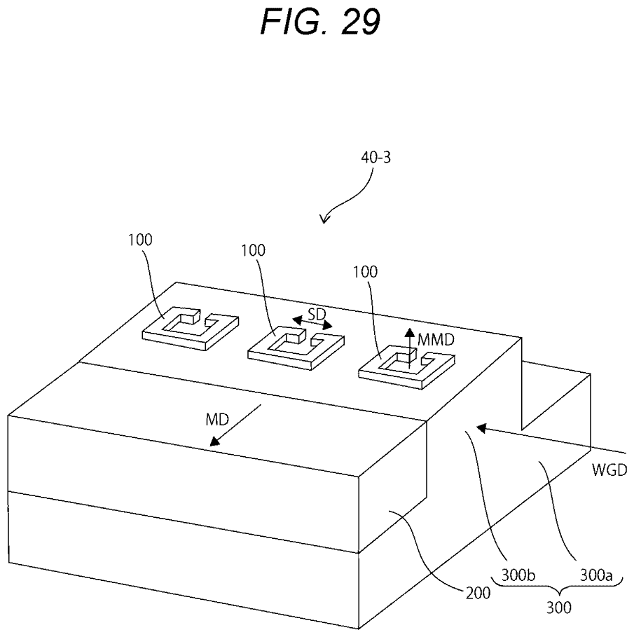

As illustrated in FIG. 29, in the wave control device 40-3 according to Example 3, the wave control device 40-3 further includes a waveguide member 300 including a core 300b of a waveguide of an electromagnetic wave. As an example, the waveguide member 300 includes a base portion 300a in addition to the core 300b. In the waveguide member 300, the core 300b that is a ridge is provided on the base portion 300a having a flat plate shape.

A metamaterial 100 is provided on an upper surface of the core 300b, and a magnetic material 200 is provided on one side surface of the core 300b. Here, a plurality of the metamaterials 100 are regularly (for example, at equal intervals) provided substantially parallel to a waveguide direction WGD (a longitudinal direction of the magnetic material 200) of the electromagnetic wave to be controlled.

The waveguide member 300 is molded by processing a substrate (for example, Si substrate) or the like transparent to a wavelength of the electromagnetic wave in order to guide the electromagnetic wave to be controlled. As the metamaterial 100, for example, one made of Au can be used, and as the magnetic material 200, for example, one made of YIG can be used.

In the wave control device 40-3, a magnetic moment direction MMD of a split-ring resonator as the metamaterial 100 is substantially perpendicular to the waveguide direction WGD of the electromagnetic wave, and the magnetic moment direction MMD of the split-ring resonator is substantially perpendicular to a magnetization direction MD of the magnetic material 200. Moreover, in the wave control device 40-3, a split direction SD (break direction) of the split-ring resonator as the metamaterial 100 is substantially parallel to the waveguide direction WGD of the electromagnetic wave and substantially perpendicular to the magnetization direction MD of the magnetic material 200.

### (Wave Control Device According to Example 4)

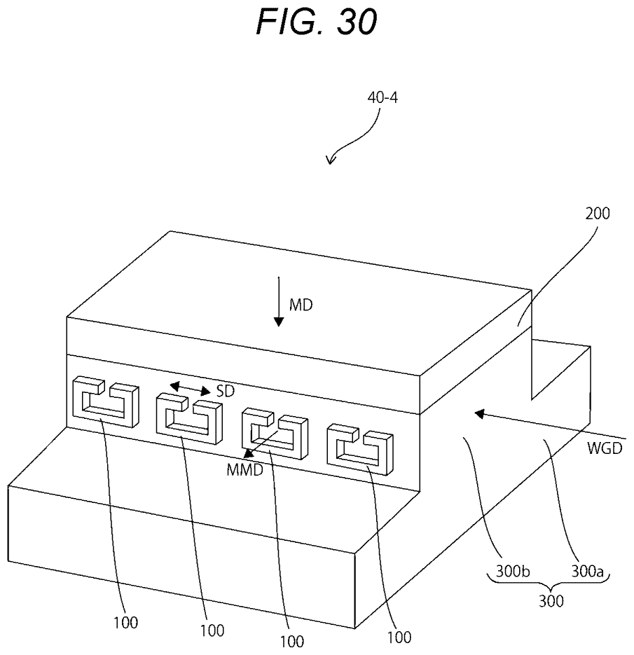

As illustrated in FIG. 30, a wave control device 40-4 according to Example 4 has a configuration substantially similar to the wave control device 40-3 according to Example 3 except that a metamaterial 100 is provided on a side surface of a core 300b and a magnetic material 200 is provided on an upper surface of the core 300b.

Also in the wave control device 40-4, a split direction SD (break direction) of a split-ring resonator as the metamaterial 100 is substantially parallel to a waveguide direction WGD of an electromagnetic wave and substantially perpendicular to a magnetization direction MD of the magnetic material 200.

(Wave control medium according to Example 5)

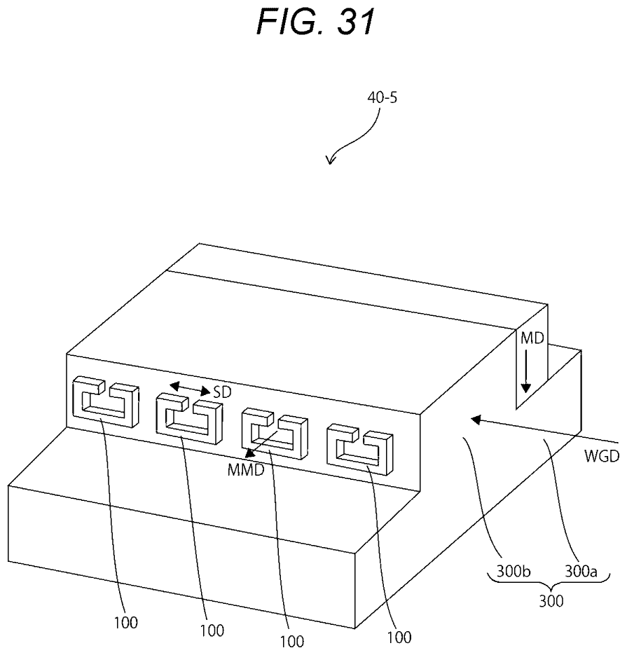

As illustrated in FIG. 31, a wave control device 40-5 according to Example 5 has a configuration substantially similar to the wave control device 40-3 according to Example 3 except that a metamaterial 100 is provided on one side surface out of one side surface and the other side surface facing each other of a core 300b and a magnetic material 200 is provided on the other side surface.

Also in the wave control device 40-5, a split direction SD (break direction) of a split-ring resonator as the metamaterial 100 is substantially parallel to a waveguide direction WGD of an electromagnetic wave and substantially perpendicular to a magnetization direction MD of the magnetic material 200.

According to the wave control device 60 according to the sixth embodiment described above, it is possible to obtain an effect similar to that of the wave control device 50 according to the fifth embodiment.

### 5. Wave Control Device According to Fifth Embodiment of Present Technology

### (Configuration of Wave Control Device)

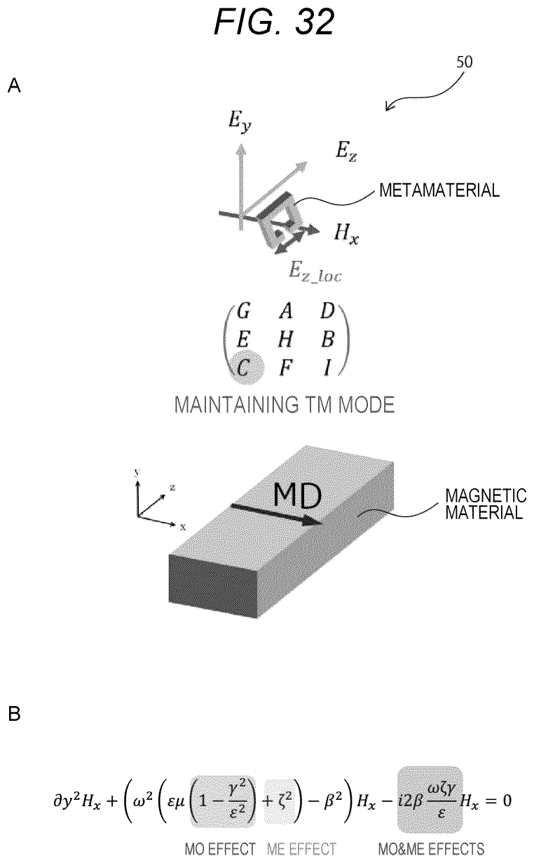

Hereinafter, a wave control device according to a fifth embodiment of the present technology will be described with reference to the drawings. 32A is a conceptual diagram of a wave control device 50 according to the fifth embodiment. FIG. 32B is a diagram illustrating a wave equation of an electromagnetic wave controlled by the wave control device 50 according to the fifth embodiment. Hereinafter, a description will be given appropriately using an xyz three-dimensional orthogonal coordinate system (for example, a left-handed coordinate system) illustrated in FIG. 32A.

As illustrated in FIG. 32A as an example, in the wave control device 50, a metamaterial 100 is disposed and a magnetization direction MD of a magnetic material 200 is set such that at least an interaction between the electromagnetic effect and the magneto-optical effect occurs with respect to an electromagnetic wave.

In the wave control device 50, the metamaterial 100 may be disposed and the magnetization direction MD of the magnetic material 200 may be set such that the electromagnetic effect and the magneto-optical effect further occur with respect to the electromagnetic wave.

In the wave control device 50 according to the fifth embodiment, as illustrated in FIG. 32A as an example, an axial direction (substantially x-axis direction) of a split-ring resonator as the metamaterial 100 is substantially perpendicular to a waveguide direction (substantially z-axis direction) of an electromagnetic wave, and a magnetic moment direction (substantially x-axis direction) of the split-ring resonator and a magnetization direction MD (substantially x-axis direction) of the magnetic material 200 are substantially parallel (more specifically, the directions substantially coincide). Moreover, in the wave control medium 50 according to the fifth embodiment, a split direction (substantially z-axis direction) of the split-ring resonator as the metamaterial 100 is substantially parallel to the waveguide direction (substantially z-axis direction) of the electromagnetic wave.

### (Operation of Wave Control Device)

The wave control device 50 can control the electromagnetic wave guided in the TM mode while performing mode matching (while maintaining the TM mode) by a combination of the arrangement of such the metamaterial 100 and the magnetization direction of the magnetic material 200. Moreover, the wave equation of the electromagnetic wave controlled by the wave control device 50 is expressed by the following Formula (5) (see FIG. 32B), and it can be seen that the MO effect and the ME effect and an interaction between the MO effect and the ME effect are exhibited.

$$\partial {y}^{2} {H}_{x} + [ {ω}^{2} ( μ ε ( 1 - {γ}^{2} / {ε}^{2} ) + {ζ}^{2} - {β}^{2} ) ] {H}_{x} - 2 i β ( ω ζ γ / ε ) {H}_{x} = 0 \qquad ( 5 )$$

Here, it is assumed that iγ is input to b that is an element related to the MO effect, and that ζ is input to C that is an element related to the ME effect.

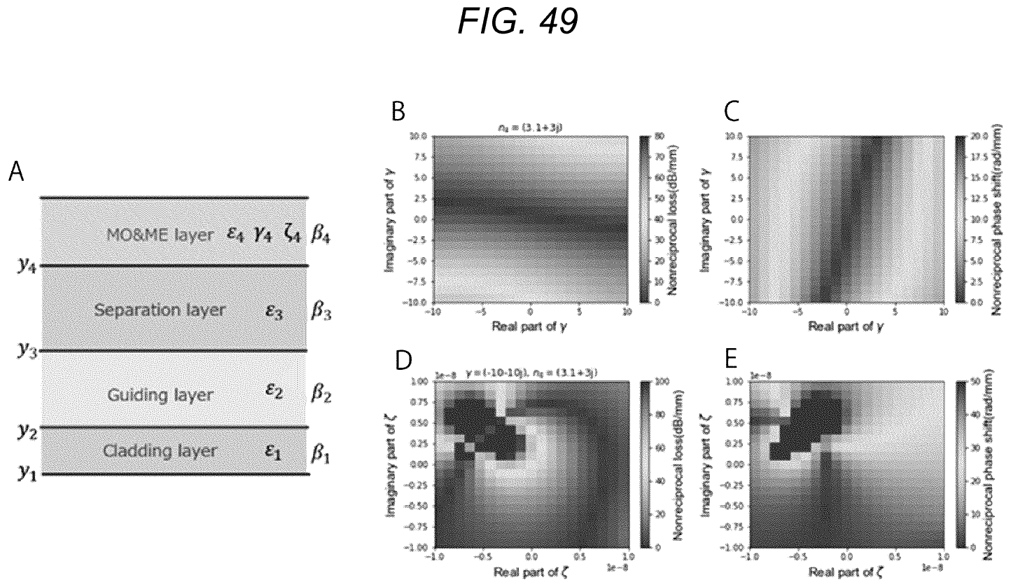

In the wave control device 50, non-reciprocity, which is a function due to the MO effect, is greatly enhanced as compared with a case where only a magnetic material is used (FIG. 3B). In the wave control device 50, the non-reciprocity of the medium including the metamaterial 100 and the magnetic material 200 disposed as illustrated in FIG. 32A is obtained by calculating a difference in propagation loss (non-reciprocal loss difference) and a phase difference (non-reciprocal phase difference) between a forward wave and a backward wave from a propagation constant β calculated using numerical analysis by the transfer matrix method in a slab waveguide type structure of FIG. 49A.

The non-reciprocal loss difference in a case where an uppermost layer is formed of the magnetic material 200 and only the MO effect occurs in the slab waveguide type structure of FIG. 49A is illustrated in FIG. 49B, and the non-reciprocal phase difference is illustrated in FIG. 49C. In the slab waveguide type structure of FIG. 49A, the non-reciprocal loss difference in the case where the uppermost layer is formed of the metamaterial 100 and the magnetic material 200 disposed as illustrated in FIG. 32A, and the MO effect and the ME effect and an interaction between the MO effect and the ME effect occur is illustrated in FIG. 49D, and the non-reciprocal phase difference is illustrated in FIG. 49E. The non-reciprocal loss difference in FIG. 49D illustrates a larger value than the non-reciprocal loss difference in FIG. 49B. The non-reciprocal phase difference in FIG. 49E illustrates a larger value than the non-reciprocal phase difference in FIG. 49C.

### (Effect of Wave Control Device)

The wave control device 50 according to the fifth embodiment includes the metamaterial 100 and the magnetic material 200. In this case, the controllability of the electromagnetic wave can be improved by effectively combining the arrangement of the metamaterial 100 and the magnetization direction of the magnetic material 200.

In the wave control device 50 according to the fifth embodiment, the metamaterial 100 is disposed and the magnetization direction MD of the magnetic material 200 is set such that at least the interaction between the electromagnetic effect and the magneto-optical effect occurs with respect to the electromagnetic wave. Thus, the controllability of the electromagnetic wave can be sufficiently improved.

In the wave control device 50, it is preferable that the metamaterial 100 is disposed and the magnetization direction MD of the magnetic material is set such that the electromagnetic effect and the magneto-optical effect further occur with respect to the electromagnetic wave. Thus, the electromagnetic wave can be substantially completely controlled.

According to the wave control device 50, it is also possible to obtain an effect substantially similar to that of the wave control device 10 according to the first embodiment.

Hereinafter, some examples (more specific concepts) of the wave control device 50 according to the fifth embodiment of the present technology will be described.

### (Wave Control Medium According to Example 1)

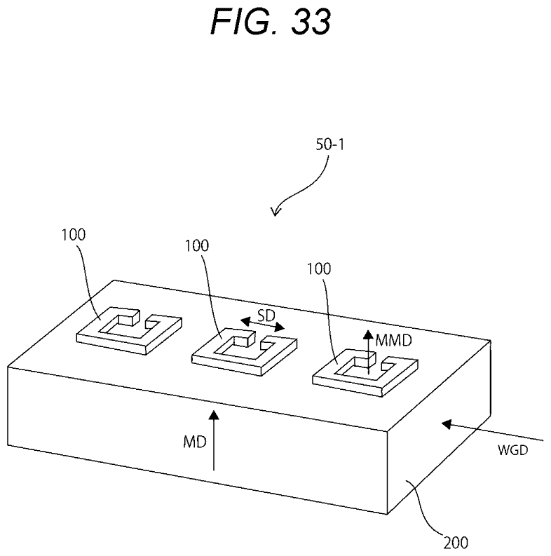

In a wave control device 50-1 according to Example 1, as illustrated in FIG. 33, a core of a waveguide of an electromagnetic wave is a magnetic material 200. In the wave control device 50-1, a metamaterial 100 is provided on an outer surface (for example, a side surface having a larger area) of the magnetic material 200 as a core. Here, a plurality of the metamaterials 100 are regularly (for example, at equal intervals) provided substantially parallel to a waveguide direction WGD (a longitudinal direction of the magnetic material 200) of the electromagnetic wave to be controlled.

In the wave control device 50-1, a magnetic moment direction MMD of a split-ring resonator as the metamaterial 100 and the waveguide direction WGD of the electromagnetic wave are substantially perpendicular, and the magnetic moment direction MMD of the split-ring resonator and a magnetization direction MD of the magnetic material 200 are substantially parallel (more specifically, the directions substantially coincide). Moreover, in the wave control device 50-1, a split direction SD (break direction) of the split-ring resonator as the metamaterial 100 is substantially parallel to the waveguide direction WGD of the electromagnetic wave.

### (Wave Control Medium According to Example 2)

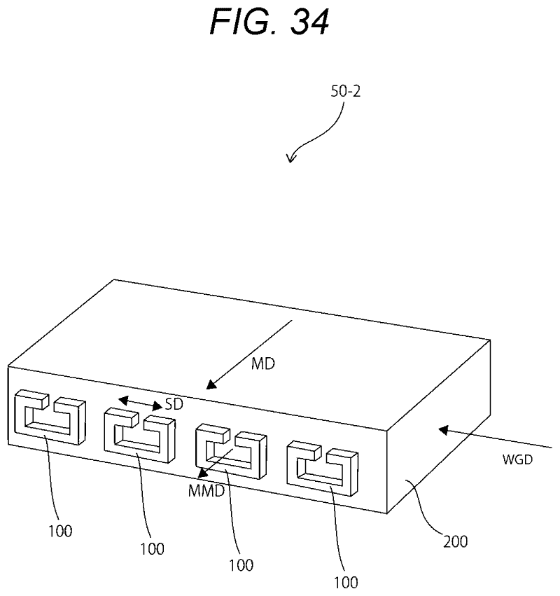

As illustrated in FIG. 34, a wave control device 50-2 according to Example 2 has a configuration substantially similar to the wave control device 50-1 according to Example 1 except that a metamaterial 100 is provided on another outer surface (for example, a side surface having a smaller area) of a magnetic material 200 as a core.

Also in the wave control device 50-2, a split direction SD (break direction) of a split-ring resonator as the metamaterial 100 is substantially parallel to a waveguide direction WGD of an electromagnetic wave.

### (Wave Control Medium According to Example 3)

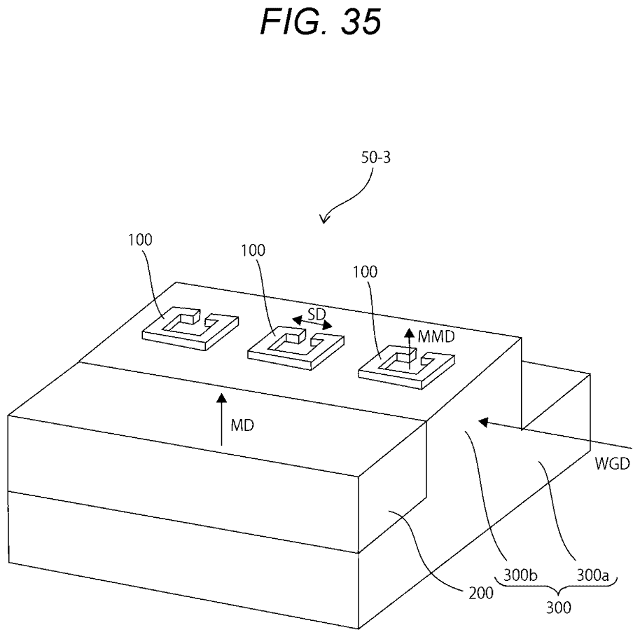

As illustrated in FIG. 35, a wave control device 50-3 according to Example 3 further includes a waveguide member 300 including a core 300b of a waveguide of an electromagnetic wave. As an example, the waveguide member 300 includes a base portion 300a in addition to the core 300b. In the waveguide member 300, the core 300b that is a ridge is provided on the base portion 300a having a flat plate shape.

A metamaterial 100 is provided on an upper surface of the core 300b, and a magnetic material 200 is provided on one side surface of the core 300b. Here, a plurality of the metamaterials 100 are regularly (for example, at equal intervals) provided substantially parallel to a waveguide direction WGD (a longitudinal direction of the magnetic material 200) of the electromagnetic wave to be controlled.

The waveguide member 300 is molded by processing a substrate (for example, Si substrate) or the like transparent to a wavelength of the electromagnetic wave in order to guide the electromagnetic wave to be controlled. As the metamaterial 100, for example, one made of Au can be used, and as the magnetic material 200, for example, one made of YIG can be used.

In the wave control device 50-3, a magnetic moment direction MMD of a split-ring resonator as the metamaterial 100 and the waveguide direction WGD of the electromagnetic wave are substantially perpendicular, and the magnetic moment direction MMD of the split-ring resonator and a magnetization direction MD of the magnetic material 200 are substantially parallel. Moreover, in the wave control device 50-1, a split direction SD (break direction) of the split-ring resonator as the metamaterial 100 is substantially parallel to the waveguide direction WGD of the electromagnetic wave.

### (Wave Control Device According to Example 4)

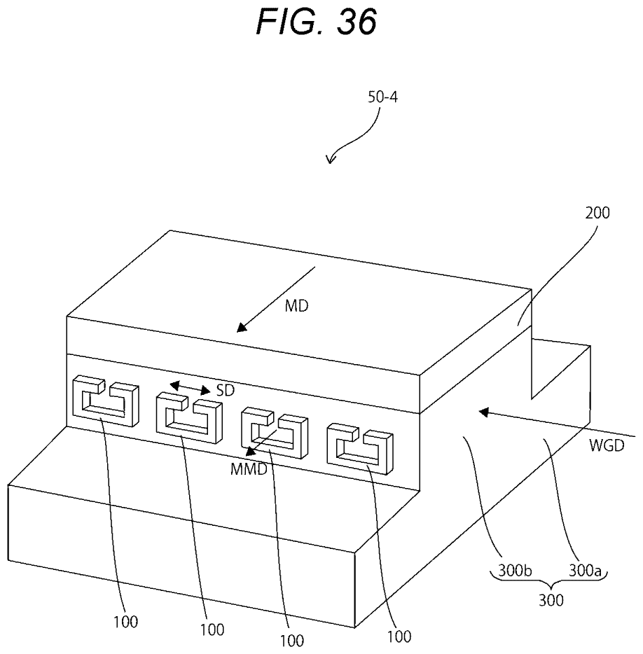

As illustrated in FIG. 36, a wave control device 50-4 according to Example 4 has a configuration substantially similar to the wave control device 50-3 according to Example 3 except that a metamaterial 100 is provided on a side surface of a core 300b and a magnetic material 200 is provided on an upper surface of the core 300b.

Also in the wave control device 50-4, a split direction SD (break direction) of a split-ring resonator as the metamaterial 100 is substantially parallel to a waveguide direction WGD of an electromagnetic wave.

### (Wave Control Medium According to Example 5)

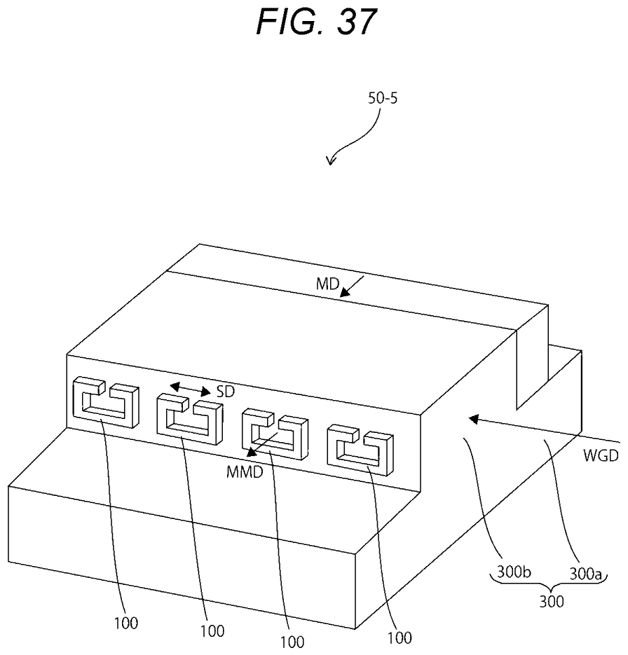

As illustrated in FIG. 37, a wave control device 50-5 according to Example 5 has a configuration substantially similar to the wave control device 50-3 according to Example 3 except that a metamaterial 100 is provided on one side surface out of the one side surface and the other side surface facing each other of a core 300b, and a magnetic material 200 is provided on the other side surface.

Also in the wave control device 50-5, a split direction SD (break direction) of a split-ring resonator as the metamaterial 100 is substantially parallel to a waveguide direction WGD of an electromagnetic wave.

### 6. Wave Control Device According to Sixth Embodiment of Present Technology

### (Configuration of Wave Control Device)

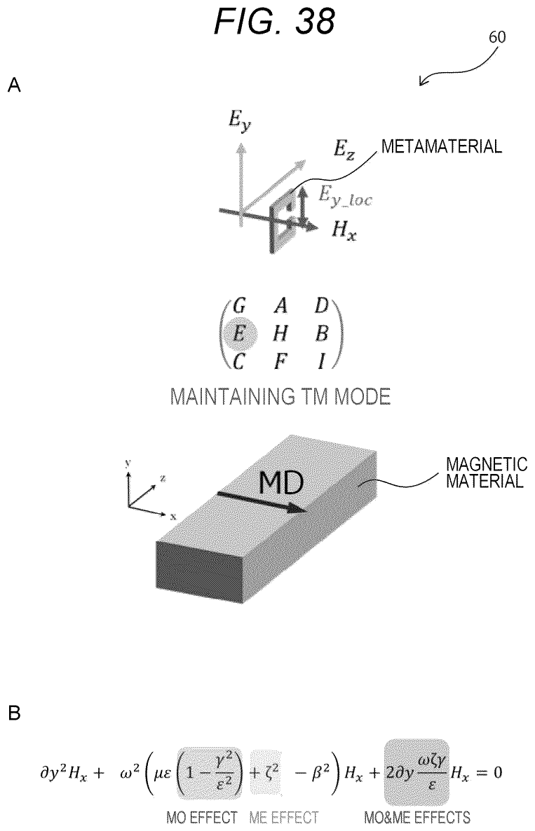

Hereinafter, a wave control device according to a sixth embodiment of the present technology will be described with reference to the drawings. FIG. 38A is a conceptual diagram of a wave control device 60 according to the sixth embodiment. FIG. 38B is a diagram illustrating a wave equation of an electromagnetic wave controlled by the wave control device 60 according to the sixth embodiment. Hereinafter, a description will be given appropriately using an xyz three-dimensional orthogonal coordinate system (for example, a left-handed coordinate system) illustrated in FIG. 38A.

As illustrated in FIG. 38A as an example, in the wave control device 60, a metamaterial 100 is disposed and a magnetization direction MD of a magnetic material 200 is set such that at least an interaction between the electromagnetic effect and the magneto-optical effect occurs with respect to an electromagnetic wave.

In the wave control device 60, the metamaterial 100 may be disposed and the magnetization direction MD of the magnetic material 200 may be set such that the electromagnetic effect and the magneto-optical effect further occur with respect to the electromagnetic wave.

In the wave control device 60 according to the sixth embodiment, as illustrated in FIG. 38A as an example, a magnetic moment direction (substantially x-axis direction) of a split-ring resonator as the metamaterial 100 and a waveguide direction (substantially z-axis direction) of the electromagnetic wave are substantially perpendicular, and the magnetic moment direction (substantially x-axis direction) of the split-ring resonator and a magnetization direction MD (substantially x-axis direction) of the magnetic material 200 are substantially parallel (more specifically, the directions substantially coincide). Moreover, in the wave control device 60, a split direction (substantially y-axis direction, cut direction) of the split-ring resonator as the metamaterial 100 is substantially perpendicular to the waveguide direction (substantially z-axis direction) of the electromagnetic wave.

### (Operation of Wave Control Device)

The wave control device 60 can control the electromagnetic wave guided in the TM mode while performing mode matching (while maintaining the TM mode) by a combination of the arrangement of such the metamaterial 100 and the magnetization direction of the magnetic material 200. Moreover, the wave equation of the electromagnetic wave controlled by the wave control device 60 is expressed by the following Formula (6) (see FIG. 38B), and it can be seen that the MO effect and the ME effect and an interaction between the MO effect and the ME effect are exhibited.

$$\partial {y}^{2} {H}_{x} + [ {ω}^{2} ( μ ε ( 1 - {γ}^{2} / {ε}^{2} ) + {ζ}^{2} - {β}^{2} ) ] {H}_{x} - 2 \partial y ( ω ζ γ / ε ) {H}_{x} = 0 \qquad ( 6 )$$

Here, it is assumed that iγ is input to b that is an element related to the MO effect, and that ζ is input to E that is an element related to the ME effect.

### (Effect of Wave Control Device)

According to the wave control device 60 according to the sixth embodiment, it is possible to obtain an effect similar to that of the wave control device 50 according to the fifth embodiment.

Hereinafter, some examples (more specific concepts) of the wave control device 60 according to the sixth embodiment of the present technology will be described.

### (Wave Control Medium According to Example 1)

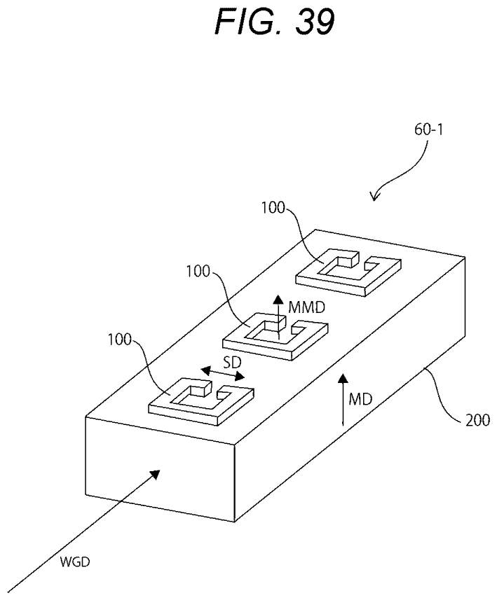

In a wave control device 60-1 according to Example 1, as illustrated in FIG. 39, a core of a waveguide of an electromagnetic wave is a magnetic material 200. In the wave control device 60-1, a metamaterial 100 is provided on one outer surface (for example, a side surface having a larger area) of the magnetic material 200 as the core. Here, a plurality of the metamaterials 100 are regularly (for example, at equal intervals) provided substantially parallel to a waveguide direction WGD (a longitudinal direction of the magnetic material 200) of the electromagnetic wave to be controlled.

In the wave control device 60-1, a magnetic moment direction MMD of a split-ring resonator as the metamaterial 100 and the waveguide direction WGD of the electromagnetic wave are substantially perpendicular, and the magnetic moment direction MMD of the split-ring resonator and a magnetization direction MD of the magnetic material 200 are substantially parallel (more specifically, the directions substantially coincide). Moreover, in the wave control device 60-1, a split direction SD (break direction) of the split-ring resonator as the metamaterial 100 is substantially perpendicular to the waveguide direction WGD of the electromagnetic wave.

### (Wave Control Medium According to Example 2)

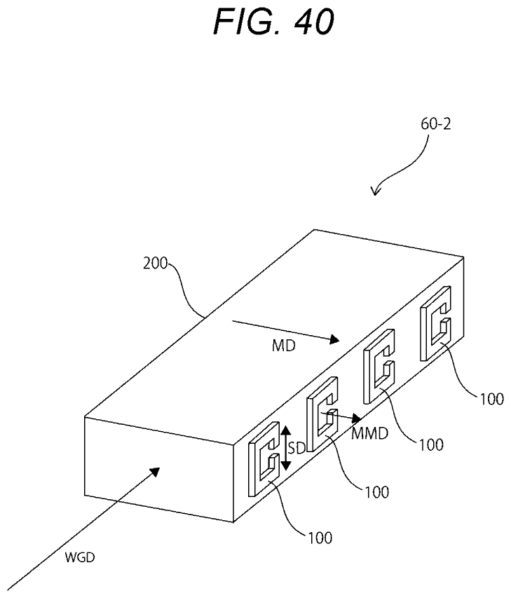

As illustrated in FIG. 40, a wave control device 60-2 according to Example 2 has a configuration substantially similar to the wave control device 60-1 according to Example 1 except that a metamaterial 100 is provided on another outer surface (for example, a side surface having a smaller area) of a magnetic material 200 as a core.

Also in the wave control device 60-2, a split direction SD (break direction) of a split-ring resonator as the metamaterial 100 is substantially perpendicular to a waveguide direction WGD of an electromagnetic wave.

### (Wave Control Medium According to Example 3)

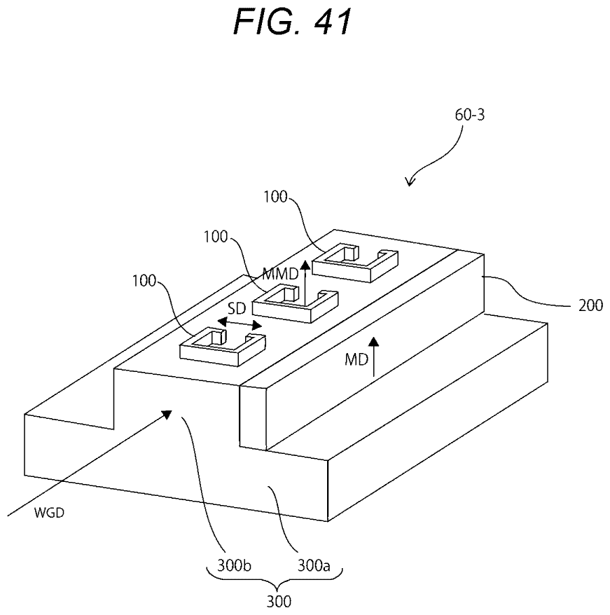

As illustrated in FIG. 41, a wave control device 60-3 according to Example 3 further includes a waveguide member 300 including a core 300b of a waveguide of an electromagnetic wave. As an example, the waveguide member 300 includes a base portion 300a in addition to the core 300b. In the waveguide member 300, the core 300b that is a ridge is provided on the base portion 300a having a flat plate shape.

A metamaterial 100 is provided on an upper surface of the core 300b, and a magnetic material 200 is provided on one side surface of the core 300b. Here, a plurality of the metamaterials 100 are regularly (for example, at equal intervals) provided substantially parallel to a waveguide direction WGD (a longitudinal direction of the magnetic material 200) of the electromagnetic wave to be controlled.

The waveguide member 300 is molded by processing a substrate (for example, Si substrate) or the like transparent to a wavelength of the electromagnetic wave in order to guide the electromagnetic wave to be controlled. As the metamaterial 100, for example, one made of Au can be used, and as the magnetic material 200, for example, one made of YIG can be used.

In the wave control device 60-3, a magnetic moment direction MMD of a split-ring resonator as the metamaterial 100 and the waveguide direction WGD of the electromagnetic wave are substantially perpendicular, and the magnetic moment direction MMD of the split-ring resonator and a magnetization direction MD of the magnetic material 200 are substantially parallel. Moreover, in the wave control device 60-3, a split direction SD (break direction) of the split-ring resonator as the metamaterial 100 is substantially perpendicular to the waveguide direction WGD of the electromagnetic wave.

### (Wave Control Device According to Example 4)

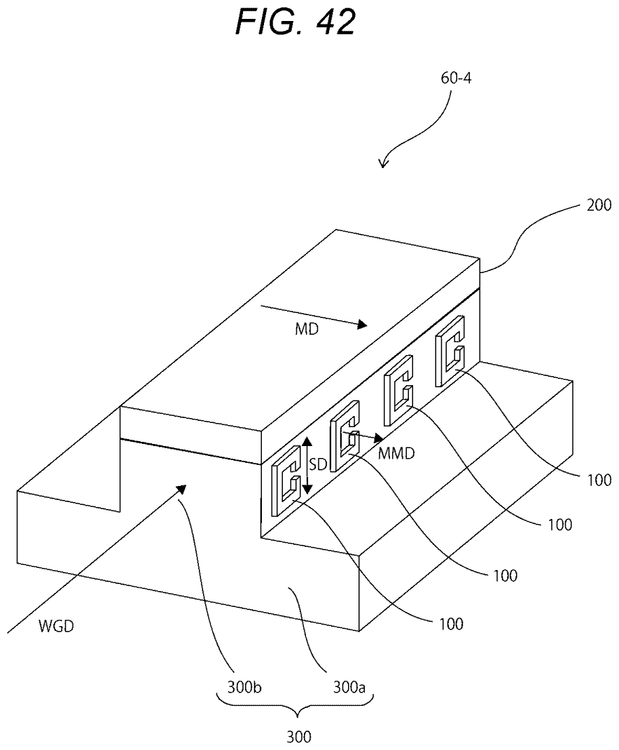

As illustrated in FIG. 42, a wave control device 60-4 according to Example 4 has a configuration substantially similar to the wave control device 60-3 according to Example 3 except that a metamaterial 100 is provided on a side surface of a core 300b and a magnetic material 200 is provided on an upper surface of the core 300b.

Also in the wave control device 60-4, a split direction SD (break direction) of a split-ring resonator as the metamaterial 100 is substantially perpendicular to a waveguide direction WGD of an electromagnetic wave.

### (Wave Control Medium According to Example 5)

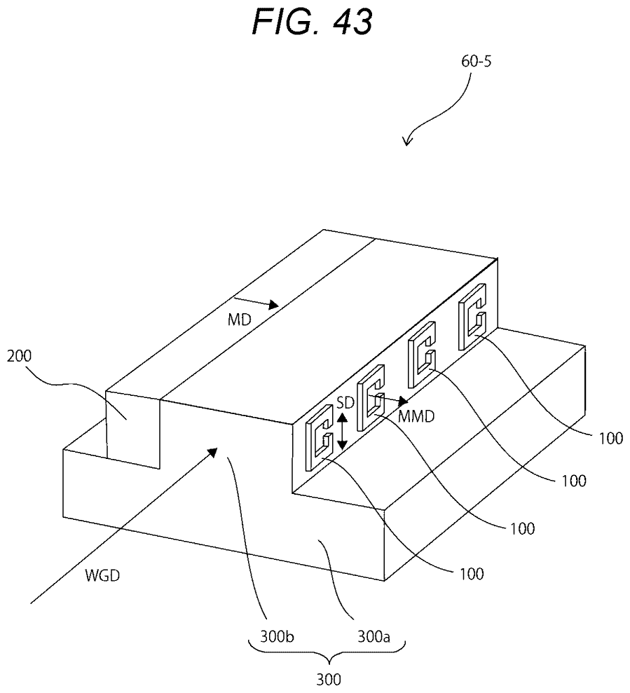

As illustrated in FIG. 43, a wave control device 60-5 according to Example 5 has a configuration substantially similar to the wave control device 60-3 according to Example 3 except that a metamaterial 100 is provided on one side surface out of one side surface and the other side surface facing each other of a core 300b and a magnetic material 200 is provided on the other side surface.

Also in the wave control device 60-5, a split direction SD (break direction) of a split-ring resonator as the metamaterial 100 is substantially perpendicular to a waveguide direction WGD of an electromagnetic wave.

### 7. Wave Control Device According to Seventh Embodiment of Present Technology

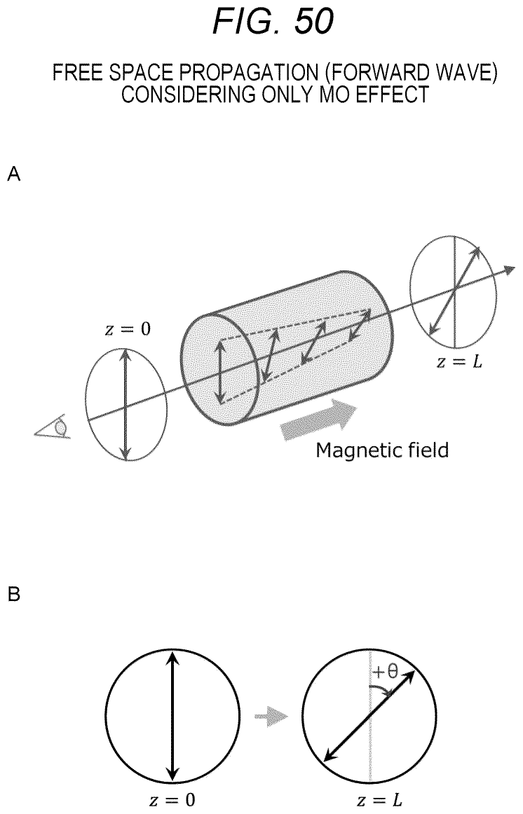

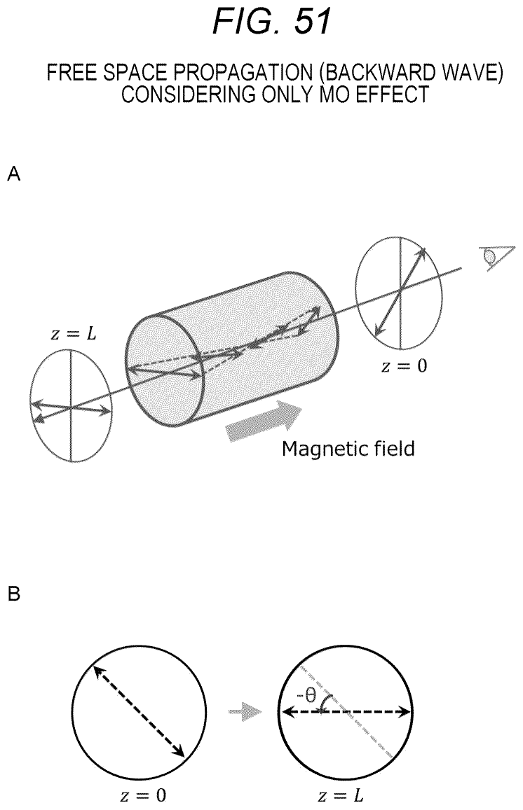

FIGS. 50A and 50B are diagrams for explaining free space propagation (forward wave) considering only the MO effect. FIGS. 51A and 51B are diagrams for explaining free space propagation (backward wave) considering only the MO effect.

In a case where only the MO effect (magneto-optical effect) is considered in free space propagation of an electromagnetic wave, a polarization direction of linearly polarized light as a forward wave rotates clockwise by θ (+ direction), for example, from before incidence (z=0) to a magnetic field applied along a propagation direction to after emission (z=L) from the magnetic field (see FIGS. 50A and 50B).

In a case where only the MO effect is considered in the free space propagation of the electromagnetic wave, a polarization direction of linearly polarized light as a backward wave (backward traveling wave) rotates counterclockwise by θ (− direction), for example, from before incidence (z=0) to a magnetic field applied along the propagation direction to after emission (z=L) from the magnetic field (see FIGS. 51A and 51B).

That is, in a case where only the MO effect is considered in the free space propagation of the electromagnetic wave, directions of the polarization rotation (rotation of the linearly polarized light) of the forward wave and the backward wave propagated in the magnetic field are opposite to each other. That is, the MO effect has non-reciprocal polarization rotation controllability.

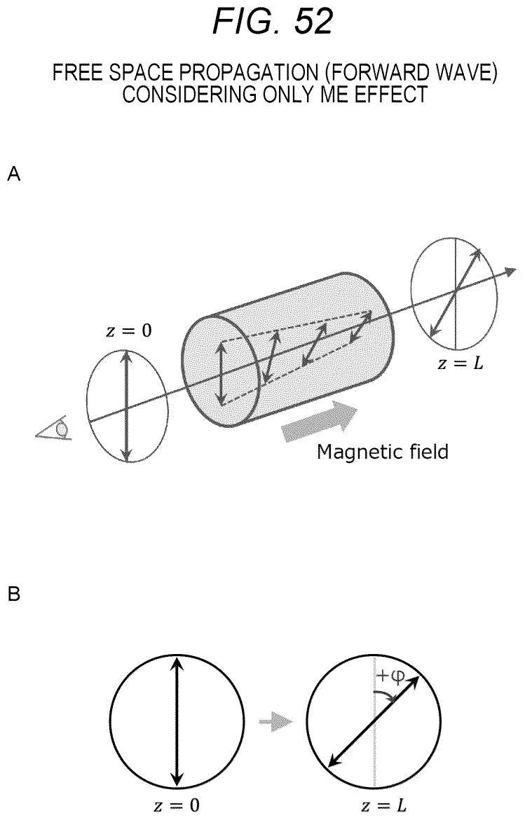

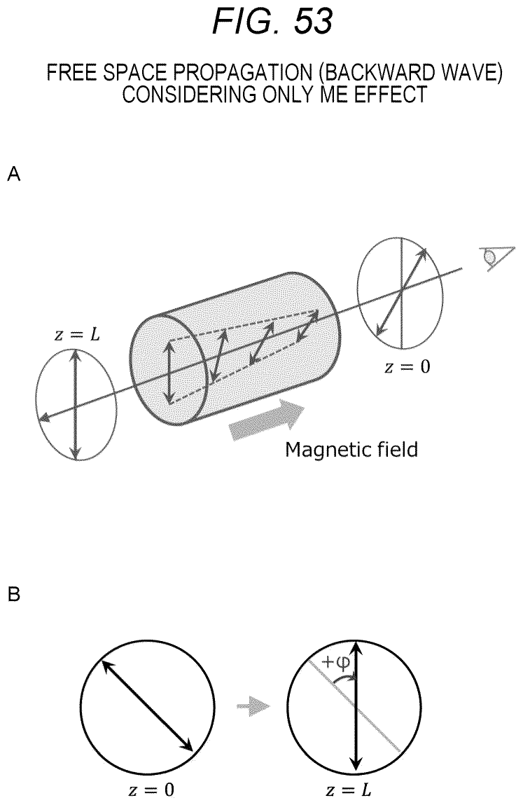

FIGS. 52A and 52B are diagrams for explaining free space propagation (forward wave) considering only the ME effect. FIGS. 53A and 53B are diagrams for explaining free space propagation (backward wave) considering only the ME effect.

In a case where only the ME effect (electromagnetic effect) is considered (particularly, in a case where a value of the parameter Z related to the ME effect is an imaginary number) in free space propagation of an electromagnetic wave, a polarization direction of linearly polarized light as a forward wave rotates clockwise by φ (+ direction), for example, from before incidence (z=0) to a magnetic field applied along a propagation direction to after emission (z=L) from the magnetic field (see FIGS. 52A and 52B).

In a case where only the ME effect is considered (particularly, in a case where the value of the parameter ζ related to the ME effect is an imaginary number) in the free space propagation of the electromagnetic wave, a polarization direction of linearly polarized light as a backward wave (backward traveling wave) rotates clockwise by φ (+ direction), for example, from before incidence (z=0) to a magnetic field applied along the propagation direction to after emission (z=L) from the magnetic field (see FIGS. 53A and 53B).

That is, in a case where only the ME effect is considered in the free space propagation of the electromagnetic wave, directions of the polarization rotation (rotation of the linearly polarized light) of the forward wave and the backward wave propagated in the magnetic field are the same. That is, the ME effect has reciprocal polarization rotation controllability.

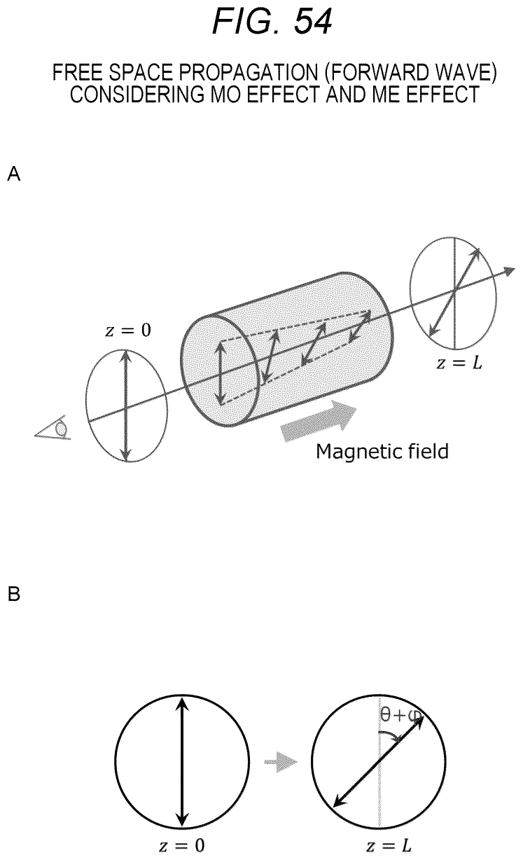

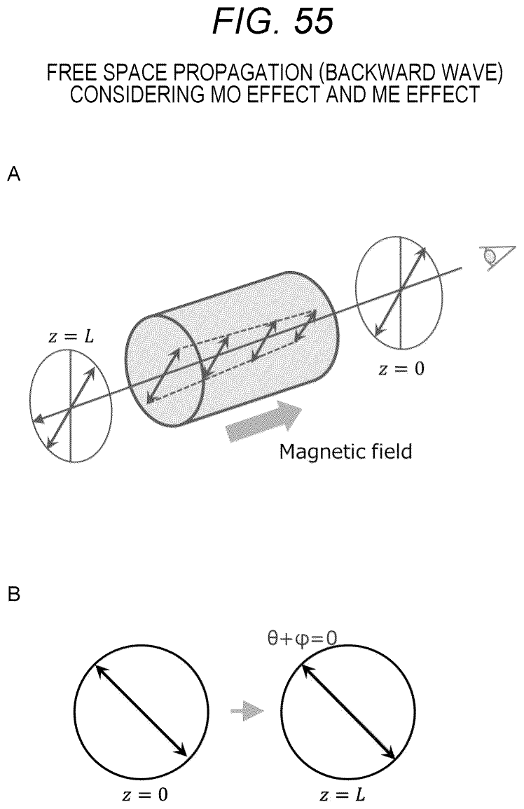

FIGS. 54A and 54B are diagrams for explaining an example of free space propagation (forward wave) considering the MO effect and the ME effect. FIGS. 55A and 55B are diagrams for explaining an example of free space propagation (backward wave) considering the MO effect and the ME effect.

In a case where the MO effect and the ME effect are considered in free space propagation of an electromagnetic wave, a polarization direction of linearly polarized light as a forward wave can be rotated, for example, clockwise (+ direction) by θ+φ (>0) from before incidence to a magnetic field applied along the propagation direction (z=0) to after emission from the magnetic field (z=L) (see FIGS. 54A and 54B).

In a case where the MO effect and the ME effect are considered in the free space propagation of the electromagnetic wave, it is possible not to rotate a polarization direction of linearly polarized light as a backward wave from before incidence (z=0) to a magnetic field applied along the propagation direction to after emission (z=L) from the magnetic field (θ+φ=0) (see FIGS. 55A and 55B).

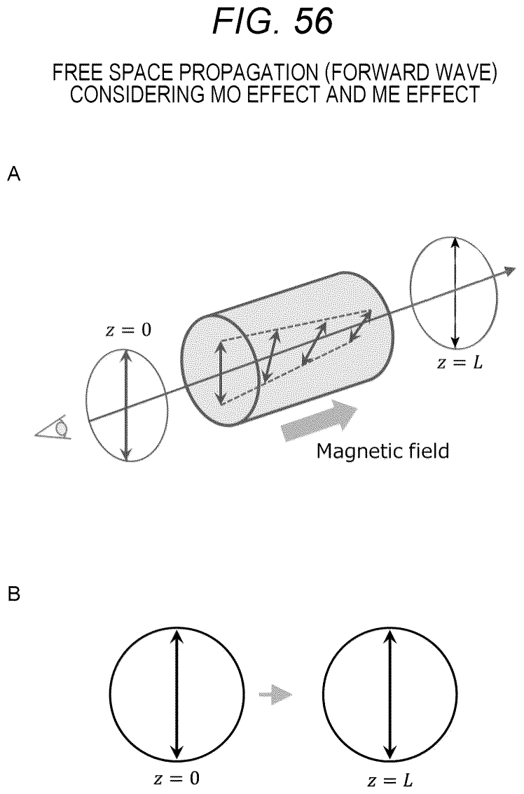

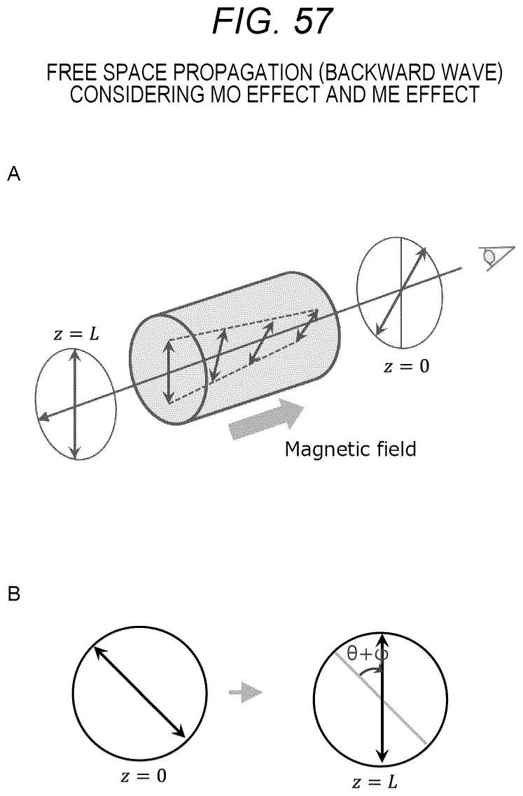

FIGS. 56A and 56B are diagrams for explaining another example of free space propagation (forward wave) considering the MO effect and the ME effect. FIGS. 57A and 57B are diagrams for explaining another example of free space propagation (backward wave) considering the MO effect and the ME effect.

In a case where the MO effect and the ME effect are considered in free space propagation of an electromagnetic wave, it is possible not to rotate a polarization direction of linearly polarized light as a forward wave from before incidence (z=0) to a magnetic field applied along the propagation direction to after emission (z=L) from the magnetic field (θ+φ=0) (see FIGS. 56A and 56B).

In a case where the MO effect and the ME effect are considered in the free space propagation of the electromagnetic wave, a polarization direction of linearly polarized light as a backward wave can be rotated, for example, clockwise (+ direction) by θ+φ (>0) from before incidence (z=0) to a magnetic field applied along the propagation direction to after emission (z=L) from the magnetic field (see FIGS. 57A and 57B).

As can be seen from the above description, by combining the non-reciprocal polarization rotation controllability of the MO effect and the reciprocal polarization rotation controllability of the ME effect, it is possible to rotate the polarization direction of only one of the forward wave and the backward wave propagated in the magnetic field.

The inventors have developed a wave control device according to a seventh embodiment as a wave control device for embodying this new knowledge. Hereinafter, a wave control device according to the seventh embodiment will be described in detail with some examples.

### (Wave Control Device According to Example 1)

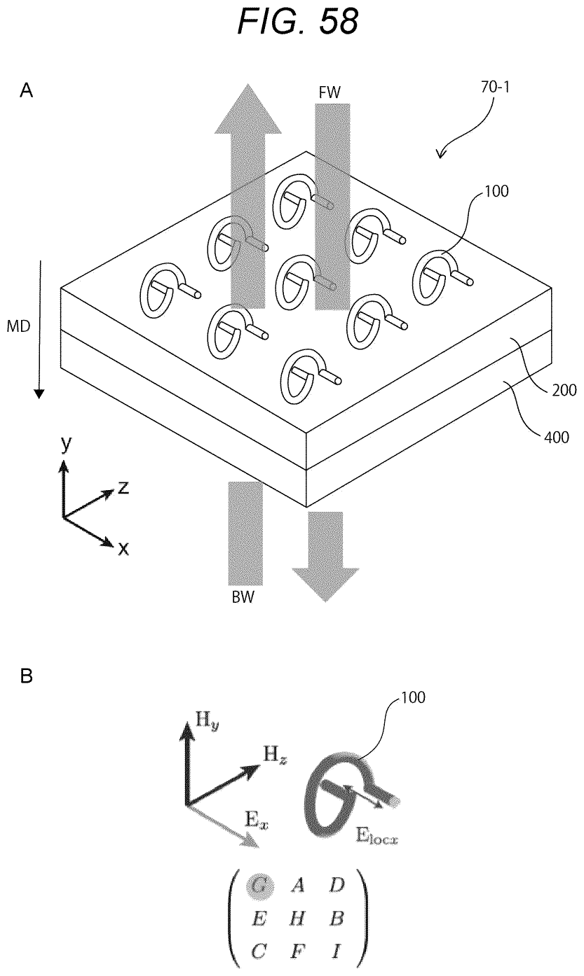

FIG. 58A is a perspective view of a wave control device 70-1 according to Example 1 of the seventh embodiment of the present technology. FIG. 58B is a diagram for explaining an arrangement of a metamaterial 100 in the wave control device 70-1 in FIG. 58A, the arrangement capable of exhibiting unidirectionally limited polarization controllability. Hereinafter, a description will be given using a three-dimensional orthogonal coordinate system illustrated in FIG. 58A as appropriate.

In the wave control device 70-1, as illustrated in FIG. 58A, a metamaterial 100 is disposed and a magnetization direction MD of a magnetic material 200 is set such that only a polarization state of one of a forward wave FW and a backward wave BW of an electromagnetic wave to be controlled changes (such that unidirectionally limited polarization controllability is exhibited).

Specifically, in the wave control device 70-1, the metamaterial 100 is disposed and the magnetization direction M of the magnetic material 200 is set such that a first effective refractive index difference that is a difference in effective refractive index between right circularly polarized light and left circularly polarized light of the forward wave FW as the electromagnetic wave to be controlled (a difference in refractive index felt by the right circularly polarized light and the left circularly polarized light) and a second effective refractive index difference that is a difference in effective refractive index between right circularly polarized light and left circularly polarized light of the backward wave BW as the electromagnetic wave (a difference in refractive index felt by the right circularly polarized light and the left circularly polarized light) are different from each other. In particular, in a case where a difference between first and second effective refractive index differences is relatively large, it is possible to change only the polarization state of one of the forward wave FW and the backward wave BW (specifically, to rotate only a polarization direction of one of the forward wave FW and the backward wave BW).

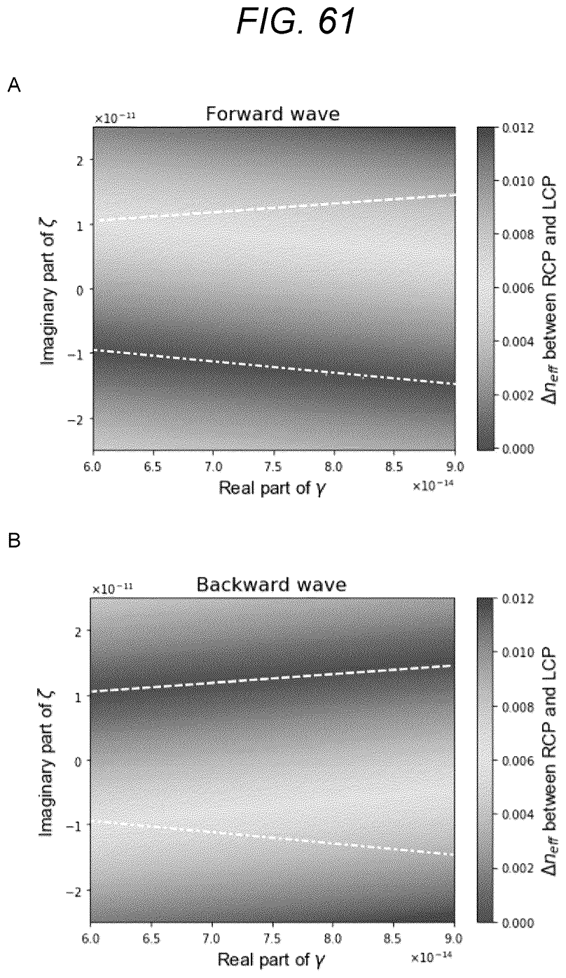

FIGS. 61A and 61B are diagrams for explaining conditions under which the unidirectionally limited polarization controllability is exhibited. In each of FIGS. 61A and 61B, the horizontal axis represents the parameter γ related to the MO effect, and the vertical axis represents the parameter ζ related to the ME effect. FIG. 61A illustrates a difference in effective refractive index (first effective refractive index difference) between right circularly polarized light and left circularly polarized light of a forward wave by gradation (shading). FIG. 61B illustrates a difference in effective refractive index (second effective refractive index difference) between right circularly polarized light and left circularly polarized light of a backward wave by gradation (shading). For example, by selecting values on broken lines in FIGS. 61A and 61B as the values of γ and ζ, the first effective refractive index difference can be made relatively large and the second effective refractive index difference can be made relatively small, and eventually, only a polarization direction of the forward wave FW can be rotated. For example, by selecting a value on a one-dot chain line in FIGS. 61A and 61B as the values of γ and ζ, the first effective refractive index difference can be made relatively small and the second effective refractive index difference can be made relatively large, and eventually, only a polarization direction of the backward wave BW can be rotated.

Returning to FIG. 58A, in the wave control device 70-1, the metamaterial 100 and the magnetic material 200 are disposed on a propagation path of the electromagnetic wave to be controlled (forward wave FW and backward wave BW). The metamaterial 100 and the magnetic material 200 are disposed side by side along the propagation direction (for example, the y-axis direction) of the electromagnetic wave. Here, the magnetization direction MD (application direction of an external magnetic field) of the magnetic material 200 is a direction (for example, the −y direction) along the propagation direction of the electromagnetic wave. In this case, a value is input to the non-diagonal component a (see FIG. 3A) of the MO tensor. That is, non-reciprocal polarization rotation control by the MO effect can be performed on the electromagnetic wave.

As an example, the magnetic material 200 is a flat plate member made of a magnetic body and is supported by a support substrate 400. As an example, both the magnetic material 200 and the support substrate 400 are disposed parallel to an xz plane. A plurality of the metamaterials 100 are provided in an array (for example, in a matrix along the xz plane) on the magnetic material 200. Examples of the support substrate 400 include a semiconductor substrate such as a Si substrate or a Ge substrate, and a silicon on insulator (SOI) substrate. The magnetic material 200 and the support substrate 400 are preferably transparent to a wavelength of the electromagnetic wave to be controlled.

As an example, each of the metamaterials 100 has a chirality structure. Specifically, each of the metamaterials 100 includes, for example, a spiral body. Here, the number of turns of the spiral body is one, but may be two or more. Each of the metamaterials 100 is disposed such that a magnetic moment direction (pitch direction, axial direction) of the spiral body is substantially orthogonal to a magnetization direction MD of the magnetic material 200 (specifically, substantially parallel to the x-axis direction). In this case, a value is input to a diagonal component G of the ME tensor (see FIG. 58B). That is, it is possible to perform reciprocal polarization rotation control by the ME effect on the electromagnetic wave.

In the wave control device 70-1 configured as described above, the non-reciprocal polarization rotation control by the MO effect and the reciprocal polarization rotation control by the ME effect can be performed in combination with respect to the electromagnetic wave to be controlled, and eventually, only a polarization direction of one of the forward wave FW and the backward wave BW can be rotated.

Since the wave control device 70-1 has such unidirectionally limited polarization controllability, it can be expected to be used as, for example, a wave control device of a polarization control element or an optical isolator.

### (Wave Control Device According to Example 2)

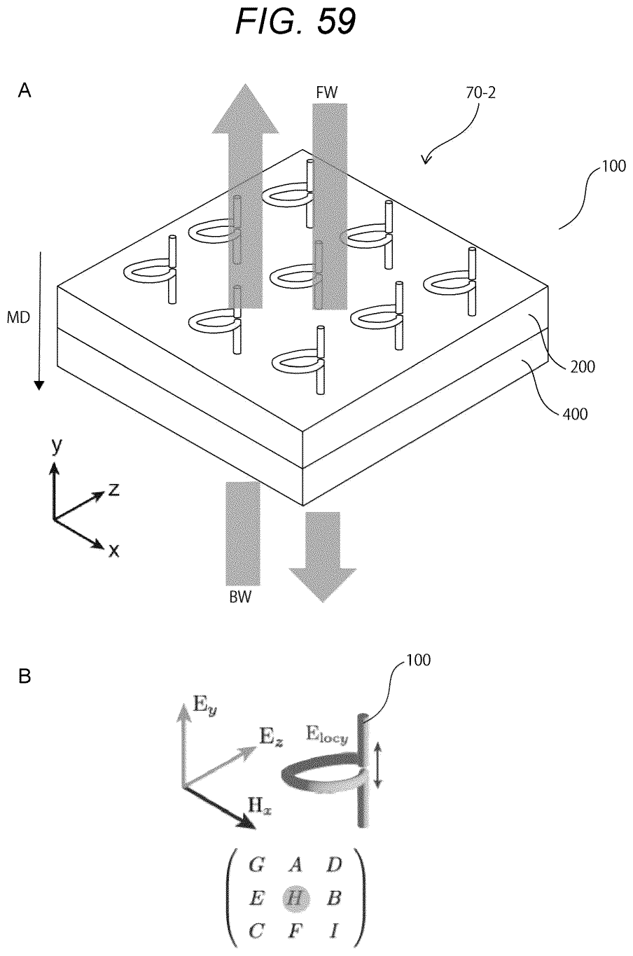

FIG. 59A is a perspective view of a wave control device 70-2 according to Example 2 of the seventh embodiment of the present technology. FIG. 59B is a diagram for explaining an arrangement of a metamaterial 100 in the wave control device 70-2 in FIG. 59A, the arrangement capable of exhibiting unidirectionally limited polarization controllability.

As illustrated in FIGS. 59A and 59B, the wave control device 70-2 has a configuration similar to the wave control device 70-1 according to Example 1 except that an arrangement (posture) of the metamaterial 100 is different.

In the wave control device 70-2, each metamaterial 100 is disposed such that a magnetic moment direction (pitch direction, axial direction) of a spiral body is substantially parallel to a magnetization direction MD of a magnetic material 200 (specifically, substantially parallel to the y-axis direction). In this case, a value is input to a diagonal component H of the ME tensor (see FIG. 59B).

The wave control device 70-2 has operation and effect similar to those of the wave control device 70-1 according to Example 1.

### (Wave Control Device According to Example 3)

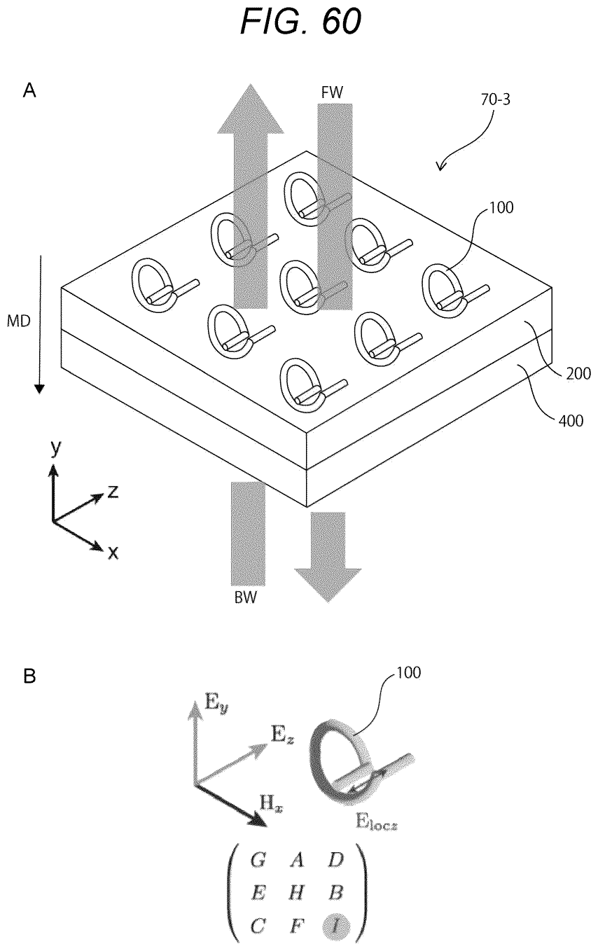

FIG. 60A is a perspective view of a wave control device 70-3 according to Example 3 of the seventh embodiment of the present technology. FIG. 60B is a diagram for explaining an arrangement of a metamaterial 100 in the wave control device 70-2 in FIG. 60A, the arrangement capable of exhibiting unidirectionally limited polarization controllability.

As illustrated in FIGS. 60A and 60B, the wave control device 70-3 has a configuration similar to the wave control device 70-1 according to Example 1 except that an arrangement (posture) of the metamaterial 100 is different.

In the wave control device 70-3, each metamaterial 100 is disposed such that the magnetic moment direction (pitch direction, axial direction) of a spiral body is substantially parallel to a z axis (substantially orthogonal to a magnetization direction MD). In this case, a value is input to a diagonal component I of the ME tensor (see FIG. 60B).

The wave control device 70-3 has operation and effect similar to those of the wave control device 70-1 according to Example 1.

In the wave control device according to each example of the seventh embodiment described above, the shape, arrangement, and number of metamaterials 100 can be appropriately changed. For example, the metamaterial 100 may have any shape as long as it has chirality. For example, the array arrangement may be a staggered arrangement or a one-dimensional arrangement. For example, the number of metamaterials 100 is not limited to a plurality, and may be a single.

### 8. Specific Example of Shape of Metamaterial

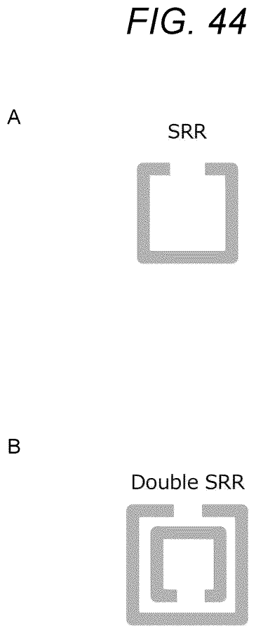

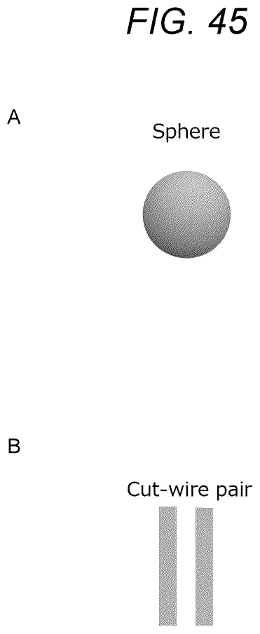

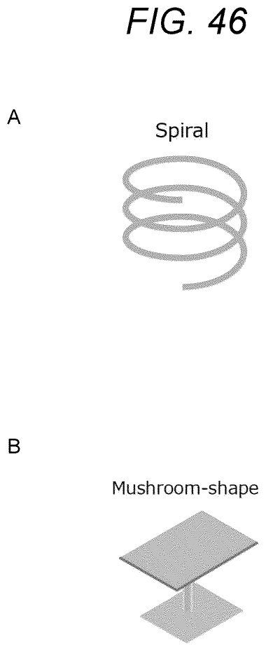

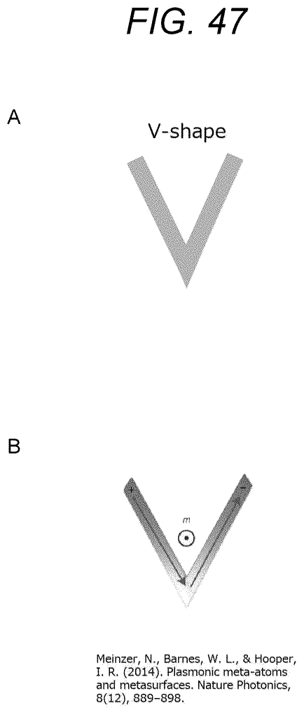

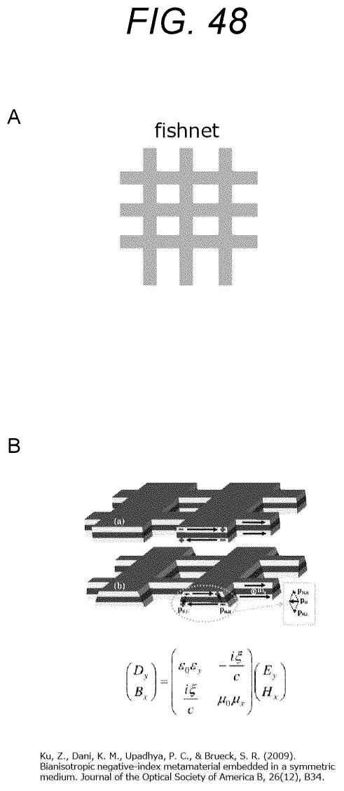

The metamaterial included in the wave control device according to the present technology preferably has a shape in which magnetization (or electric polarization) is induced by an electric field (or magnetic field), and the induced electric polarization or magnetization depends on an arrangement of the metamaterial. Examples of a shape of such a metamaterial include, in addition to the split-ring resonator (SSR, see FIG. 44A) described in each of the embodiments described above, a double split-ring resonator (DSSR, see FIG. 44B), a sphere (see FIG. 45A), a cut-wire pair (see FIG. 45B), a spiral (see FIG. 46A), a mushroom-shape (see FIG. 46B), a V-shape (see FIGS. 47A and 47B), and a fishnet shape (see FIGS. 48A and 48B). Note that FIGS. 47A and 47B are cited from Meinzer, N., Barnes, W. L., & Hooper, I. R. (2014). Plasmonic meta-atoms and metasurfaces. Nature Photonics, 8(12), 889-898. FIGS. 48A and 48B are cited from Ku, Z., Dani, K. M., Upadhya, P. C., & Brueck, S. R. (2009). Bianisotropicnegative-index metamaterial embedded in a symmetric medium. Journal of the OpticalSociety of America B, 26(12), B34. The resonator having each of the above shapes can also be made of a material similar to and have a size similar to the split-ring resonator described in each of the embodiments described above. Note that even in a case where the metamaterial has the double split resonator, it is possible to adopt a combination similar to the combination of the arrangement of the split-ring resonator and the magnetization direction of the magnetic material described in each of the embodiments described above, and thus, it is possible to obtain an effect greater than or equal to that.

Among the specific examples of the metamaterial 100 described above, in particular, as a method of integrating the metamaterial 100 having a three-dimensional shape (stereoscopic shape) with the waveguide, the metamaterial 100 may be formed by performing self-assembly by drying of a block copolymer or a mixed polymer solution, for example, on a constituent element (core or cladding) of the waveguide, the metamaterial 100 may be formed by performing 3D printing of a photocurable resin, a thermosetting resin, a photo-soluble resin, or a heat-soluble resin on the constituent element of the waveguide, the metamaterial 100 may be formed by patterning a metal on the constituent element of the waveguide to form a metal thin wire, and then spontaneously contracting the metal thin wire, or the metamaterial 100 may be formed by spontaneously growing a metal structure from a surface processing unit patterned with a metal on the constituent element of the waveguide.

Note that, depending on the shape of the metamaterial, the component of the corresponding ME tensor changes, that is, the direction of magnetization (or electric polarization) induced in a case where an electric field (or magnetic field) is applied in a certain direction varies depending on the shape of the metamaterial. Therefore, it is preferable that the metamaterial is disposed and the magnetization direction of the magnetic material is set according to the shape of the metamaterial such that the electromagnetic effect and the magneto-optical effect, and/or the interaction between the electromagnetic effect and the magneto-optical effect occur with respect to the electromagnetic wave.

Moreover, it is preferable that the metamaterial is disposed and the magnetization direction of the magnetic material is set according to the shape of the metamaterial such that at least the interaction between the electromagnetic effect and the magneto-optical effect occurs with respect to the electromagnetic wave. Moreover, in this case, it is preferable that the metamaterial is disposed and the magnetization direction of the magnetic material is set according to the shape of the metamaterial such that the electromagnetic effect and the magneto-optical effect further occur with respect to the electromagnetic wave.

As described above, in the wave control device according to each embodiment of the present technology, it is preferable that the metamaterial 100 is disposed and the magnetization direction MD of the magnetic material 200 is set such that the electromagnetic effect and the magneto-optical effect, and/or the interaction between the electromagnetic effect and the magneto-optical effect occur with respect to the electromagnetic wave. Thus, the controllability of the electromagnetic wave can be improved.

### 9. Modification of Present Technology

The wave control device according to each embodiment described above can be appropriately changed.

For example, some of the configurations of the wave control devices according to the examples of the embodiments described above may be combined within a range not contradictory to each other.

For example, the wave control device may include a metamaterial and a magnetic material, and may be disposed around a waveguide of an electromagnetic wave. That is, the wave control device may not include the waveguide of the electromagnetic wave as a component.

In each of the embodiments described above, the case where the arrangement of the metamaterial and the magnetization direction of the magnetic material are combined so as to control the electromagnetic wave guided in the TM mode while maintaining the TM mode (so as to achieve mode matching) has been described as an example. However, the arrangement of the metamaterial and the magnetization direction of the magnetic material may be combined so as to control the electromagnetic wave guided in the TM mode without maintaining the TM mode (so as to achieve mode mismatch).

For example, the waveguide of the electromagnetic wave may include a core and a cladding. In this case, the core and/or the cladding may be a magnetic material or a part of the waveguide member. Specifically, the waveguide of the electromagnetic wave may be, for example, a waveguide in which a flat plate-shaped core is sandwiched between two flat plate-shaped claddings (slab type), a waveguide in which a core is surrounded by a cladding (embedded type), a waveguide in which a core is surrounded by a cladding and a part of the core is exposed to the outside (semi-embedded type), or a waveguide in which a rail-shaped cladding is provided on a flat plate-shaped core (ridge type).

For example, the metamaterial and the magnetic material may be provided on the same side of the core of the waveguide.

For example, the metamaterial and/or the magnetic material may be provided on the incident end surface and/or the emission end surface of the core of the waveguide.

The wave control device according to each of the embodiments described above can also be applied to, for example, a wavelength conversion element, an arithmetic element, a sensor, and the like.

### 10. Application of Present Technology

In addition to the above-described applications, the wave control device according to each of the embodiments and modifications described above can also be applied to a transmission/reception device that performs transmission/reception or a reception/emission device that performs light reception/emission, a small antenna, a low profile antenna, a frequency selection filter, an artificial magnetic conductor, an electroband gap member, a noise countermeasure member, an isolator, a radio wave lens, a radar member, an optical lens, an optical film, an optical element for terahertz, a radio wave and an optical camouflage/invisibility member, a heat dissipation member, a heat shielding member, a heat storage member, modulation/demodulation of an electromagnetic wave, wavelength conversion, and the like, electromagnetic wave reflection (electromagnetic wave control), electromagnetic wave transmission (electromagnetic wave control), a non-linear device, a speaker, an energy absorption material, a black material, a quenching material, an energy conversion material, a radio wave lens, an optical lens, a color filter, a frequency selection filter, an electromagnetic wave reflection material, a beam phase control device, a polarization control element, an optical isolator, and the like.

Note that the present technology can have the following configurations.

(1) A wave control device including a metamaterial and a magnetic material.

(2) The wave control device according to (1), in which the metamaterial is disposed and a magnetization direction of the magnetic material is set such that an electromagnetic effect and a magneto-optical effect, and/or an interaction between the electromagnetic effect and the magneto-optical effect occur with respect to an electromagnetic wave.

(3) The wave control device according to (2), in which the metamaterial is disposed and the magnetization direction of the magnetic material is set such that at least the interaction between the electromagnetic effect and the magneto-optical effect occurs with respect to the electromagnetic wave.

(4) The wave control device according to (3), in which the metamaterial is disposed and the magnetization direction of the magnetic material is set such that the electromagnetic effect and the magneto-optical effect further occur with respect to the electromagnetic wave.

(5) The wave control device according to any one of (2) to (4), in which the metamaterial is provided around a waveguide of the electromagnetic wave.

(6) The wave control device according to (5), in which the metamaterial is provided integrally with the waveguide.

(7) The wave control device according to (5) or (6), in which a core of the waveguide is the magnetic material.

(8) The wave control device according to (7), in which the metamaterial is provided on an outer surface of the core.

(9) The wave control device according to (5) or (6), further including a waveguide member including a core of the waveguide.

(10) The wave control device according to (9), in which the metamaterial and the magnetic material are provided on an outer surface of the core.

(11) The wave control device according to any one of (2) to (4), in which the metamaterial and the magnetic material are disposed on a propagation path of the electromagnetic wave.

(12) The wave control device according to (11), in which the metamaterial and the magnetic material are disposed side by side along a propagation direction of the electromagnetic wave.

(13) The wave control device according to (11) or (12), in which the metamaterial is provided on the magnetic material.

(14) The wave control device according to any one of (11) to (13), in which the metamaterial is disposed and the magnetization direction of the magnetic material is set such that only a polarization state of one of a forward wave and a backward wave of the electromagnetic wave changes.

(15) The wave control device according to any one of (11) to (14), in which the metamaterial is disposed and the magnetization direction of the magnetic material is set such that a difference in effective refractive index between right circularly polarized light and left circularly polarized light of the forward wave of the electromagnetic wave is different from a difference in effective refractive index between right circularly polarized light and left circularly polarized light of the backward wave of the electromagnetic wave.

(16) The wave control device according to any one of (2) to (10), in which the metamaterial includes a split-ring resonator, a magnetic moment direction of the split-ring resonator and a waveguide direction of the electromagnetic wave are substantially perpendicular, and the magnetic moment direction and the magnetization direction of the magnetic material are substantially parallel.

(17) The wave control device according to (16), in which a split direction of the split-ring resonator is substantially parallel to the waveguide direction.

(18) The wave control device according to (16), in which a split direction of the split-ring resonator is substantially perpendicular to the waveguide direction.

(19) The wave control device according to any one of (2) to (10), in which the metamaterial includes a split-ring resonator, a magnetic moment direction of the split-ring resonator and a waveguide direction of the electromagnetic wave are substantially perpendicular, and the magnetic moment direction and the magnetization direction of the magnetic material are substantially perpendicular.

(20) The wave control device according to (19), in which a split direction of the split-ring resonator is substantially perpendicular to both the waveguide direction and the magnetization direction.

(21) The wave control device according to (19), in which a split direction of the split-ring resonator is substantially perpendicular to the waveguide direction and substantially parallel to the magnetization direction.

(22) The wave control device according to (19), in which a split direction of the split-ring resonator is substantially parallel to both the waveguide direction and the magnetization direction.

(23) The wave control device according to (19), in which a split direction of the split-ring resonator is substantially parallel to the waveguide direction and substantially perpendicular to the magnetization direction.

(24) The wave control device according to any one of (1) to (23), in which the metamaterial includes any of a cut-wire pair resonator, a spiral resonator, a mushroom resonator, a V-shaped resonator, and a fishnet resonator.

(25) The wave control device according to any one of (2) to (24), in which the electromagnetic wave is guided in a TM mode.

(26) The wave control device according to any one of (1) to (25), in which the magnetization direction of the magnetic material is set by an external magnetic field.

(27) A wavelength conversion element including the wave control device according to any one of (1) to (26).

(28) An arithmetic element including the wave control device according to any one of (1) to (26).

(29) A sensor including the wave control device according to any one of (1) to (26).

(30) A polarization control element including the wave control device according to any one of (1) to (26).

(31) An optical isolator including the wave control device according to any one of (1) to (26).

### REFERENCE SIGNS LIST

10, 10-1 to 10-5, 20, 20-1 to 20-5, 30, 30-1 to 30-5, 40, 40-1 to 40-5, 50, 50-1 to 50-5, 60, 60-1 to 60-5 Wave control device
100 Metamaterial
200 Magnetic material
300 Waveguide member
300b Core
MMD Magnetic moment direction
WGD Waveguide direction
MD Magnetization direction
SD Split direction.

1. A wave control device comprising a metamaterial and a magnetic material.

2. The wave control device according to claim 1, wherein the metamaterial is disposed and a magnetization direction of the magnetic material is set such that an electromagnetic effect and a magneto-optical effect, and/or an interaction between the electromagnetic effect and the magneto-optical effect occur with respect to an electromagnetic wave.

3. The wave control device according to claim 2, wherein the metamaterial is disposed and the magnetization direction of the magnetic material is set such that at least the interaction between the electromagnetic effect and the magneto-optical effect occurs with respect to the electromagnetic wave.

4. The wave control device according to claim 3, wherein the metamaterial is disposed and the magnetization direction of the magnetic material is set such that the electromagnetic effect and the magneto-optical effect further occur with respect to the electromagnetic wave.

5. The wave control device according to claim 2, wherein the metamaterial is disposed around a waveguide of the electromagnetic wave.

6. The wave control device according to claim 5, wherein the metamaterial is provided integrally with the waveguide.

7. The wave control device according to claim 5, wherein a core of the waveguide is the magnetic material.

8. The wave control device according to claim 7, wherein the metamaterial is provided on an outer surface of the core.

9. The wave control device according to claim 5, further comprising a waveguide member including a core of the waveguide.

10. The wave control device according to claim 9, wherein the metamaterial and the magnetic material are provided on an outer surface of the core.

11. The wave control device according to claim 2, wherein the metamaterial and the magnetic material are disposed on a propagation path of the electromagnetic wave.

12. The wave control device according to claim 11, wherein the metamaterial and the magnetic material are disposed side by side along a propagation direction of the electromagnetic wave.

13. The wave control device according to claim 12, wherein the metamaterial is provided on the magnetic material.

14. The wave control device according to claim 11, wherein the metamaterial is disposed and the magnetization direction of the magnetic material is set such that only a polarization state of one of a forward wave and a backward wave of the electromagnetic wave changes.

15. The wave control device according to claim 14, wherein the metamaterial is disposed and the magnetization direction of the magnetic material is set such that a difference in effective refractive index between right circularly polarized light and left circularly polarized light of the forward wave of the electromagnetic wave is different from a difference in effective refractive index between right circularly polarized light and left circularly polarized light of the backward wave of the electromagnetic wave.

16. The wave control device according to claim 2, wherein
the metamaterial includes a split-ring resonator,
a magnetic moment direction of the split-ring resonator and a waveguide direction of the electromagnetic wave are substantially perpendicular, and
the magnetic moment direction and the magnetization direction of the magnetic material are substantially parallel.

17. The wave control device according to claim 16, wherein a split direction of the split-ring resonator is substantially parallel to the waveguide direction.

18. The wave control device according to claim 16, wherein a split direction of the split-ring resonator is substantially perpendicular to the waveguide direction.

19. The wave control device according to claim 2, wherein
the metamaterial includes a split-ring resonator,
a magnetic moment direction of the split-ring resonator and a waveguide direction of the electromagnetic wave are substantially perpendicular, and
the magnetic moment direction and the magnetization direction of the magnetic material are substantially perpendicular.

20. The wave control device according to claim 19, wherein a split direction of the split-ring resonator is substantially perpendicular to both the waveguide direction and the magnetization direction.

21. The wave control device according to claim 19, wherein a split direction of the split-ring resonator is substantially perpendicular to the waveguide direction and substantially parallel to the magnetization direction.

22. The wave control device according to claim 19, wherein a split direction of the split-ring resonator is substantially parallel to both the waveguide direction and the magnetization direction.

23. The wave control device according to claim 19, wherein a split direction of the split-ring resonator is substantially parallel to the waveguide direction and substantially perpendicular to the magnetization direction.

24. The wave control device according to claim 2, wherein the metamaterial includes any of a cut-wire pair resonator, a spiral resonator, a mushroom resonator, a V-shaped resonator, and a fishnet resonator.

25. The wave control device according to claim 2, wherein the electromagnetic wave is guided in a TM mode.

26. The wave control device according to claim 2, wherein the magnetization direction of the magnetic material is set by an external magnetic field.

27. A wavelength conversion element comprising the wave control device according to claim 1.

28. An arithmetic element comprising the wave control device according to claim 1.

29. A sensor comprising the wave control device according to claim 1.

30. A polarization control element comprising the wave control device according to claim 1.

31. An optical isolator comprising the wave control device according to claim 1.
